(19) United States
(12) Patent Application Publication
(10) Pub. No.: US 2023/0176295 A1
(43) Pub. Date: Jun. 8, 2023

(54) OPTICAL CONNECTOR END SURFACE CLEANER

(71) Applicant: TOMOEGAWA CO., LTD., Tokyo (JP)

(72) Inventors: Makoto GOTO, Shizuoka-shi, Shizuoka (JP); Masayoshi SUZUKI, Shizuoka-shi, Shizuoka (JP)

(21) Appl. No.: 17/929,160

(22) PCT Filed: Mar. 2, 2021
(86) PCT No.: PCT/JP2021/007796

§ 371 Date: Sep. 1, 2022

(30) Foreign Application Priority Data
Mar. 3, 2020 (JP) 2020-036227

(51) Int. Cl. G02B 6/38; B08B 1/00; B08B 7/00

(52) U.S. Cl. CPC G02B 6/3866; B08B 1/001; B08B 7/0028; B08B 2240/02

(57) ABSTRACT

Even if the end surface of the optical connector is inclined with respect to the optical axis of the optical fiber, the optical connector end surface cleaner has sufficient cleaning ability and has high tape conveyance property when the cleaning tape is conveyed and displaced. Further, in the case where there are guide pins protruding from the end surface of the optical connector, an optical connector end surface cleaner is provided which has a cleaning capability for the optical connector end surface and the guide pins.

An optical connector end surface cleaner according to the present invention is an optical connector end surface cleaner for cleaning an end surface of an optical connector, the optical connector end surface cleaner comprising: a cleaning tape for cleaning the end surface of the optical connector in contact therewith; a cleaning head for supporting a rear surface of the cleaning tape in contact with an end surface of the optical connector when the cleaning tape is in contact with the end surface of the optical connector; and a tape supply mechanism for supplying the cleaning tape to the cleaning head, wherein the cleaning head includes at least a cleaning head distal end member, a cleaning head buffering member, and a cleaning head supporting member, and a storage elastic modulus E1 of the cleaning head buffering member at 40° C. measured in accordance with JIS K7244-4 with a frequency of 1 Hz is lower than a storage elastic modulus E2 of the cleaning head distal end member at 40° C. and a storage elastic modulus E3 of the cleaning head supporting member at 40° C. similarly measured.

### TECHNICAL FIELD

The present invention relates to an optical connector end surface cleaner to clean an end surface of a ferrule for the optical connector.

### BACKGROUND ART

As an optical connector cleaner to clean the optical connector in the related art, cleaners, in which a non-woven fabric is moved while the non-woven fabric is in contact with an end surface of a ferrule for an optical connector, have been known (see, for instance, Patent Literatures 1 and 2).

A cleaner using an adhesive tape has also been developed in place of the non-woven fabric (Patent Literature 3).

### CITATION LIST

### Patent Literature

Patent Literature 1: JP 2014-35489 A

Patent Literature 2: WO 2014/141405 A

Patent Literature 3: U.S. Pat. No. 6,498,814 B

### SUMMARY OF INVENTION

### Technical Problem

When optical fibers are connected to an optical connector, an end surface of the optical fibers should face an end surface of a ferrule for the optical connector. Thus, when dust adheres to the end surface of the ferrule for the optical connector or the end surface of the optical fiber, the transmission loss increases. For this reason, it is necessary to clean the end surface of the ferrule for the optical connector by using a cleaner.

In the optical connector, when the normal direction of the end surface of the optical connector is not parallel to the optical axis of the optical fiber, that is, there is also a type in which the end surface of the optical connector is inclined, and in this case, the end surface of the optical connector has an inclination of, for example, 5 to 20° with respect to the optical axis of the optical fiber. The optical connector also includes a guide pin protruding from an end surface of the optical connector in parallel with the optical axis of the optical fiber. Therefore, the cleaner is required to clean the end surface of the optical connector having various aspects as described above.

The cleaners of Patent Literatures 1 and 2 are for removing dust located on an end surface of a ferrule for an optical connector by a cloth. In these cleaners, when the end surface of the optical connector is inclined, the cleaner and the end surface of the optical connector cannot sufficiently come into contact with each other, and there is a possibility that the optical connector cannot be sufficiently cleaned. Further, in the optical connector in which the guide pin is protruded, the guide pin cannot be cleaned, and there is a possibility that dust or the like adhering to the guide pin may re-contaminate the end surface of the ferrule.

It is expected that the cleaner of Patent Literature 3 is difficult to generate charging and can appropriately remove dust. However, when the end surface of the optical connector is inclined, the adhesive tape and the end surface of the optical connector cannot sufficiently come into contact with each other, and there is a possibility that the optical connector cannot be sufficiently cleaned. Further, in the optical connector in which the guide pin is protruded, the guide pin cannot be cleaned, and there is a possibility that dust or the like adhering to the guide pin may re-contaminate the end surface of the ferrule.

In the cleaners of Patent Literatures 1 to 3, when a cleaning element (such as a tape) is conveyed and displaced, the cleaning element may not be wrinkled or the cleaning element (such as a tape) may not be smoothly conveyed and displaced.

It is therefore an object of the present invention to provide an optical connector end surface cleaner which has a sufficient cleaning ability even when the end surface of the optical connector is inclined with respect to the optical axis of the optical fiber, and which smoothly carries and displaces a cleaning element (tape or the like) without wrinkling of the cleaning element when the cleaning tape is conveyed and displaced (high tape conveyance property). In the case where the optical connector of the present invention has a guide pin protruding from the end surface thereof, it is an object of the present invention to provide an optical connector end surface cleaner which has accommodation holes for guide pins in the end surface of the cleaning head (end surface of a cleaning head distal end member described later).

### Solution to Problem

In order to solve the above-mentioned problems, the optical connector end surface cleaner of the present invention is characterized by including a cleaning head constituted by a constituent member having a specific storage elastic modulus. That is, the present invention is as follows.

The present invention (1) is an optical connector end surface cleaner for cleaning an end surface of an optical connector,
the optical connector end surface cleaner comprising:
a cleaning tape for cleaning the end surface of the optical connector in contact the end surface of an optical connector;
a cleaning head for supporting a rear surface of the cleaning tape in contact with an end surface of the optical connector when the cleaning tape is in contact with the end surface of the optical connector;
and a tape supply mechanism for supplying the cleaning tape to the cleaning head,
wherein the cleaning head comprises at least a cleaning head distal end member, a cleaning head buffering member, and a cleaning head supporting member,
and a storage elastic modulus E1 of the cleaning head buffering member at 40° C. measured in accordance with JIS K7244-4 with a frequency of 1Hz is lower than a storage elastic modulus E2 of the cleaning head distal end member at 40° C. and a storage elastic modulus E3 of the cleaning head supporting member at 40° C., which are similarly measured.

The present invention (2) is the optical connector end surface cleaner according to the present invention (1),
wherein at least a part of the cleaning head buffering member is arranged in contact with a position where a cleaning head distal end member is sandwiched between an end surface of the optical connector and the cleaning head buffering member on an optical axis of an optical fiber provided in the optical connector when the cleaning tape is brought into contact with the end surface of the optical connector,
and the storage elastic modulus E1 is 0.05 to 1.0 MPa.

The present invention (3) is the optical connector end surface cleaner according to the present invention (1) or (2), wherein a ratio of the storage elastic modulus E2 to the storage elastic modulus E1 (E2/E1) is 500 or more.

The present invention (4) is the optical connector end surface cleaner according to any one of the present inventions (1) to (3), wherein the storage elastic modulus E3 has a ratio to the storage elastic modulus E1 (E3/E1) is 500 or more.

The present invention (5) is the optical connector end surface cleaner according to any one of the present inventions (1) to (4), wherein the cleaning tape comprises an adhesive layer,
and a ratio of the storage elastic modulus E1 to a storage elastic modulus E4 of the adhesive layer at 40° C. measured according to JIS K7244-4 with a frequency of 1Hz (E1/E4) is 1 to 7.5.

The present invention (6) is the optical connector end surface cleaner according to the present invention (5), wherein the end surface of the optical connector has a guide pin protruded parallel to the optical axis of the optical fiber,
the cleaning head distal end member has a cleaning head end surface for pressing the cleaning tape against the end surface of the optical connector, and the cleaning head end surface has an accommodation hole (A) into which the guide pin is inserted at a position opposed to the guide pin when the cleaning head end surface is pressed against the end surface of the optical connector.

The present invention (7) is the optical connector end surface cleaner according to the present invention (6), wherein the cleaning head buffering member has an accommodation hole (B) or a concave part (b) at a position facing the accommodation hole (A) in the cleaning head distal end member.

The present invention (8) is the optical connector end surface cleaner according to any one of the present inventions (1) to (7), wherein the cleaning head end surface is a plane,
and a normal direction of the cleaning head end surface is parallel to an optical axis direction of an optical fiber provided on the end surface of the optical connector.

The present invention (9) is the optical connector end surface cleaner according to any one of the present inventions (1) to (7), wherein the cleaning head end surface is a plane,
and a normal direction of the cleaning head end surface is inclined by 5° to 20° with respect to an optical axis direction of an optical fiber provided on the end surface of the optical connector when the cleaning tape is brought into contact with the end surface of the optical connector.

The present invention (10) is the optical connector end surface cleaner according to any one of the present inventions (1) to (7), wherein the cleaning head end surface is a curved surface,
the cleaning head end surface has at least one maximum point,
and the maximum point is arranged on an optical axis of at least one optical fiber provided on the end surface of the optical connector when the cleaning tape is brought into contact with the end surface of the optical connector.

### Advantageous Effects of Invention

According to the present invention, it is possible to provide an optical connector end surface cleaner which has a sufficient cleaning ability even when the end surface of the optical connector is inclined with respect to the optical axis of the optical fiber, and which smoothly carries and displaces a cleaning element (tape or the like) without wrinkling of the cleaning element when the cleaning tape is conveyed and displaced (high tape conveyance property). In the case where the optical connector of the present invention has a guide pin protruding from the end surface thereof, it is possible to provide an optical connector end surface cleaner which has accommodation holes for guide pins in the end surface of the cleaning head (end surface of a cleaning head distal end member described later).

### BRIEF DESCRIPTION OF DRAWINGS

FIG. 1 is a perspective view showing the overall outline of an optical connector end surface cleaner 10 according to a preferred embodiment of the present invention.

FIG. 2 is a perspective view showing the overall outline of the optical connector end surface cleaner 10 according to this preferred embodiment and an optical connector OC.

FIG. 3 is a side view showing the left side surface of the optical connector end surface cleaner 10 according to this preferred embodiment.

FIG. 4 is a side view showing the right side surface of the optical connector end surface cleaner 10 according to this preferred embodiment.

FIG. 5 is a perspective view showing a state in which a right housing 110R of the optical connector end surface cleaner 10 according to this preferred embodiment is removed.

FIG. 6 is a perspective view showing a state in which a left housing 110L of the optical connector end surface cleaner 10 according to this preferred embodiment is removed.

FIG. 7 is a perspective view showing a state in which a supply reel 200 and a take-up reel 300 of the optical connector end surface cleaner 10 according to this preferred embodiment are removed.

FIG. 8 is a perspective view showing the configuration of the right housing 110R of the optical connector end surface cleaner 10 according to this preferred embodiment.

FIG. 9 is a perspective view showing the configuration of the left housing 110L of the optical connector end surface cleaner 10 according to this preferred embodiment.

FIG. 10 is a perspective view showing the configuration of a head section 40 (a cleaning head 400 and a head holder 440) of the optical connector end surface cleaner 10 according to this preferred embodiment.

FIG. 11 is a perspective view showing a path of a cleaning tape CT in the head section 40 of the optical connector end surface cleaner 10 according to this preferred embodiment.

FIG. 12 is a cross-sectional view showing a path of the cleaning tape CT in the head section 40 of the optical connector end surface cleaner 10 according to this preferred embodiment.

FIGS. 13A and 13B are cross-sectional views showing a change in movement of a take-up controller 500 of the optical connector end surface cleaner 10 according to this preferred embodiment.

FIG. 14 is a cross-sectional view showing a change in movement of the take-up controller 500 of the optical connector end surface cleaner 10 according to this preferred embodiment.

FIG. 15 is a schematic view showing a ratchet gear 322, a rack 536, and a supply reel pawl 180 of the optical connector end surface cleaner 10 according to this preferred embodiment.

FIGS. 16A to 16D are cross-sectional views showing a process of cleaning an end surface ES of a ferrule FE for an optical connector by using the optical connector end surface cleaner 10 of this preferred embodiment.

FIGS. 17A to 17D are cross-sectional views showing a process of cleaning an end surface ES of a ferrule FE for an optical connector by using the optical connector end surface cleaner 10 of this preferred embodiment.

FIG. 18A and 18B is a perspective view showing a cleaning head 400 according to this preferred embodiment and a perspective transparent view showing the arrangement of a cleaning head distal end member 410 and a cleaning head buffering member 420.

FIG. 19A and 19B is an enlarged view of a side transparent view showing the cleaning head 400 according to this preferred embodiment and a side transparent view showing the arrangement of the cleaning head distal end member 410 and the cleaning head buffering member 420.

### DESCRIPTION OF EMBODIMENTS

In the present application, the expression indicating the shape of an optical connector such as “parallel”, “planar”, “spherical”, “ellipsoidal”, “curved surface” or the like or an optical connector end surface cleaner of the present invention is used without any explanation, and does not indicate a strict shape but means such a shape in a macroscopic view. For example, if “parallel”, it is not necessary to be strictly parallel, and a parallel line, a parallel side or a parallel plane represents, for example, that the angle formed by each is 0±5°, and preferably 0±1°.

In the present application, a guide pin that is protruded from the end surface of the optical connector is shown in the case of being described as “guide pin” without any description. Similarly, in the case of the “accommodation hole”, the accommodation hole (A) alone, the accommodation hole (A) and the accommodation hole (B) or the concave part (b) are connected, and the accommodation hole (A), the accommodation hole (B) and the accommodation hole (C) or the concave part (c) are connected. The accommodation hole (A), the accommodation hole (B), the concave part (b), the accommodation hole (C), and the concave part (c) will be described later.

The storage elastic modulus in the present application is measured in accordance with JIS K7244-4 “Plastics-Determination of Dynamic Mechanical Properties—Part 4: Tensile Vibration—Non-resonant Method”. As the measurement condition, the measurement frequency is set to 1 Hz and the storage elastic modulus at a desired temperature is set. In the present invention, the measurement result of the storage elastic modulus at 40° C. under the measurement conditions is expressed as the storage elastic modulus at 40° C.

In the present application, the glass transition temperature of the adhesive is measured by a measurement method of JIS K7121: 2012 “Testing methods for transition temperatures of plastics (Amendment 1)”.

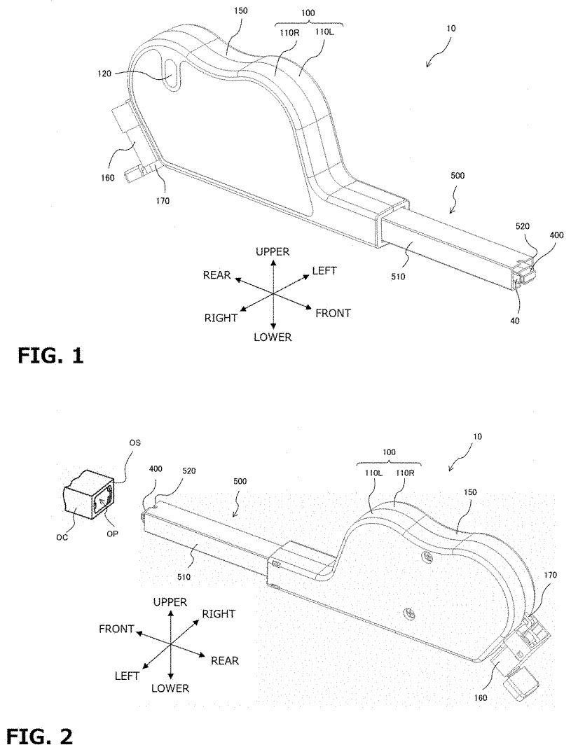

In the present application, when the cleaner of the present invention is used in contact with an end surface of an optical connector, a direction in which a cleaning head of the cleaner of the present invention comes into contact with the end surface of the optical connector on an optical axis of an optical fiber on the end surface of the optical connector is a front side or a front side of the cleaning head, and a direction in which the cleaning head is detached from the end surface of the optical connector is a rear side or a rear side of the cleaning head (see FIGS. 1 and 2).

The right side and direction from the rear side to the front side are referred to as the right side and the right direction, and the left side and direction from the rear side to the front side are referred to as the left side.

### ««<The Optical Connector End Surface Cleaner»»>

The optical connector end surface cleaner of the present invention (hereinafter referred to as a cleaner in some cases) is an optical connector end surface cleaner for cleaning the end surface of the optical connector.

The optical connector end surface cleaner includes a cleaning tape for cleaning by abutting against an end surface of the optical connector, a cleaning head for supporting and pressing a surface opposite to a surface of the cleaning tape with which an end surface of the optical connector abuts when the cleaning tape abuts against the end surface of the optical connector, and a tape supply mechanism for supplying the cleaning tape to the cleaning head.

The cleaning head according to the present invention includes at least a cleaning head distal end member, a cleaning head buffering member, and a cleaning head supporting member.

A storage elastic modulus E1 of the cleaning head buffering member at 40° C. (hereinafter sometimes simply referred to as E1) measured in accordance with JIS K7244-4 with a frequency of 1 Hz of the cleaning head buffering member according to the present invention is lower than a storage elastic modulus E2 of the cleaning head distal end member at 40° C. (hereinafter sometimes simply referred to as E2) and a storage elastic modulus E3 of the cleaning head supporting member at 40° C. (hereinafter sometimes simply referred to as E3) measured in the same manner.

Hereinafter, each part of the optical connector end surface cleaner of the present invention will be described in detail.

### «<Cleaning Tape»>

The cleaning tape according to the present invention is a member for cleaning the end surface of the optical connector. The cleaning tape is supplied to and displaced to the cleaning head by the tape supply mechanism.

When the cleaner is pressed against the end surface of the optical connector, the cleaning tape is displaced to scrape the end surface of the optical connector and wipe away a contaminant such as dust (hereinafter referred to as a wiping type cleaner), or the cleaning tape is stopped and pressed to transfer and hold the contaminant to the cleaning tape, thereby removing the contaminant from the end surface of the optical connector (hereinafter referred to as a tape fixing type cleaner). In the case of the tape fixing type cleaner, the cleaning tape is supplied to the cleaning head by the tape supply mechanism before being pressed against the end surface of the optical connector or after being pressed and detached from the end surface of the optical connector. That is, when the cleaning tape is pressed against the end surface of the optical connector, an unused part of the cleaning tape is always arranged in the cleaning head. As a result, the end surface of the optical connector is always cleaned by the unused part of the cleaning tape, and it is possible to prevent the contaminants adhering to the used cleaning tape from re-adhering.

The cleaning tape may have an adhesive layer capable of holding a contaminant (hereinafter referred to as an adhesive layer). By pressing the adhesive layer against the end surface of the optical connector, a contaminant (such as dust) present on the end surface of the optical connector is transferred (or transcribed to the adhesive layer, and the contaminant can be efficiently removed from the end surface of the optical connector. The adhesive layer can also be provided on a cleaning tape of a wiping type cleaner.

The shape of the cleaning tape is not particularly limited as long as it is a sheet shape that can be pressed against the end surface of the optical connector by the cleaning head. The cleaning tape is long and has a continuous shape. The cleaning tape is not limited to a tape shape, and may include a thread shape or a belt-like shape in which a plurality of threads is bundled. The cleaning tape is preferably flexible.

The width of the cleaning tape is not particularly limited, but may be at least equal to or greater than the width of the end surface of the ferrule for the optical connector to be cleaned, or may be equal to or greater than the width including the guide pins when the guide pins is protruded from the end surface of the optical connector. When the guide pins protrude from the end surface of the optical connector (generally, two guide pins are provided), the width of the cleaning tape used in the wiping type cleaner is equal to or smaller than the width of the gap between the guide pins.

The thickness of the cleaning tape is not particularly limited, and may be, for example, from 0.05 mm to 2 mm.

The material of the cleaning tape (hereinafter, also referred to as a base material) is not particularly limited as long as the effect of the present invention is not inhibited, and for example, a sheet-like material in which resins such as synthetic resin and natural resin, rubbers such as natural rubber and synthetic rubber, natural fiber, synthetic fiber, fiber, and paper are formed can be used. That is, an extruded resin sheet, a narrowly cut processed resin sheet, twisted fibers, a fiber woven fabric (mesh material, woven fabric, etc.), a laminated cloth, a non-woven fabric, paper, etc. can be used. When the adhesive layer can be held by the adhesive layer alone, the adhesive layer alone can be used as the cleaning tape.

It is possible to use, as the fiber woven fabric, for instance, a mesh material having a mesh structure with a mesh size of about 0.5 to 2.0 mm.

The cleaning tape may be deformed so as to follow the shape of a guide pin and an accommodation hole described later when the cleaning tape and the optical connector are brought into contact with each other, or the guide pin may penetrate the cleaning tape. In the case where the cleaning tape is deformed so as to follow the shape of the guide pin and the accommodation hole, an olefin-based or polyvinyl chloride-based synthetic resin is preferable as the cleaning tape. On the other hand, in the case where the guide pin penetrates the cleaning tape, it is preferable to use a structure which is easy to penetrate and a material which is easy to penetrate, and for example, a fiber woven fabric of fibers configured in a net shape, a laminated cloth, a non-woven fabric, or the like can be suitably used.

As the cleaning tape, a tape in which an adhesive layer is laminated on a base material can be used. The adhesive layer is laminated on the surface of the cleaning tape on the side in contact with the optical connector end surface.

In the case where the cleaning tape is made of a material including voids such as a fiber woven fabric, laminated cloth, and non-woven fabric, the adhesive layer can be formed in a state of being impregnated into voids such as a fiber woven fabric, laminated cloth, and non-woven fabric when the adhesive layer is provided. By adopting such a state, the close contact between the cleaning tape and the adhesive layer becomes strong. Therefore, when the end surface of the ferrule for the optical connector and the guide pin are removed from the cleaning tape and the adhesive layer is detached, it has the advantage of not leaving adhesive residue, which adheres to the end surface of the ferrule or guide pin for the optical connector.

A paper, non-woven fabric, woven fabric, or resin film may be preferably used as a material made of easy-to-penetrate material. Examples of the easy-to-penetrate resin that can be preferably used include, but are not particularly limited to, a resin, like a polyolefin resin such as polyethylene resin, which can be easily broken after extended to a certain length, or an easy-to-cut or -processed resin like polypropylene (PP) resin or polyethylene terephthalate (PET) resin that is uniaxially or biaxially drawn.

Among them, the use of polyethylene terephthalate (PET) makes it easy to improve the tape conveyance performance.

The material of the adhesive layer in the case where the cleaning tape has the adhesive layer is not particularly limited as long as dirt can be removed by contact with an end surface (for example, an end surface ES described later) of a ferrule (for example, a ferrule FE described later) for the optical connector and a guide pin (for example, a guide pin GP described later), and an adhesive or a pressure sensitive adhesive can be used.

Examples of the pressure sensitive adhesive include rubber-based adhesives, acrylic adhesives, silicone-based adhesives, and urethane-based adhesives. Additives such as a tackifier and a filler may be blended in these adhesives. Known adhesives have an advantage because they are readily available and the adhesive strength and the effect of preventing adhesive residue can be easily modified.

As the adhesive, for example, an olefin adhesive having weak adhesiveness or the like can be used. It is preferable that the adhesive is provided with a measure to suppress or prevent contamination of the connector end surface such as a residue of adhesive when the adhesive contacts the connector end surface and the guide pin. The bonding agent preferably exerts an action of suppressing or preventing contamination of, for instance, an adhesive residue on the connector end surface when it comes into contact with the connector end surface and the guide pin.

The glass transition temperature of the adhesive layer is not particularly limited, but is preferably, for example, more than −50° C. and less than 30° C. When the glass transition temperature of the adhesive layer is in such a range, the optical connector end surface cleaner of the present invention has superior contaminant removal performance, and the optical connector end surface and the optical fiber made of resin are hardly damaged. Here, in order to satisfy the contaminant removal performance, it is necessary to provide the adhesive layer with full adhesion to the entire ferrule end surface of the optical connector and transferability to transfer the contaminants from the optical connector end surface to the adhesive layer, and by setting the glass transition temperature of the adhesive layer to a certain range, the cleaner of the present invention can have more excellent contaminant removal performance.

In addition, the tape conveyance property of the cleaner of the present invention can be improved. Here, the tape conveyance property is a property in which the cleaning tape is smoothly conveyed and displaced without being wrinkled when the cleaning tape is conveyed and displaced, and when the tape conveyance property is poor, a hand for adjusting the cleaning tape at the time of use or the like occurs, and thus the usability of the cleaner may deteriorate.

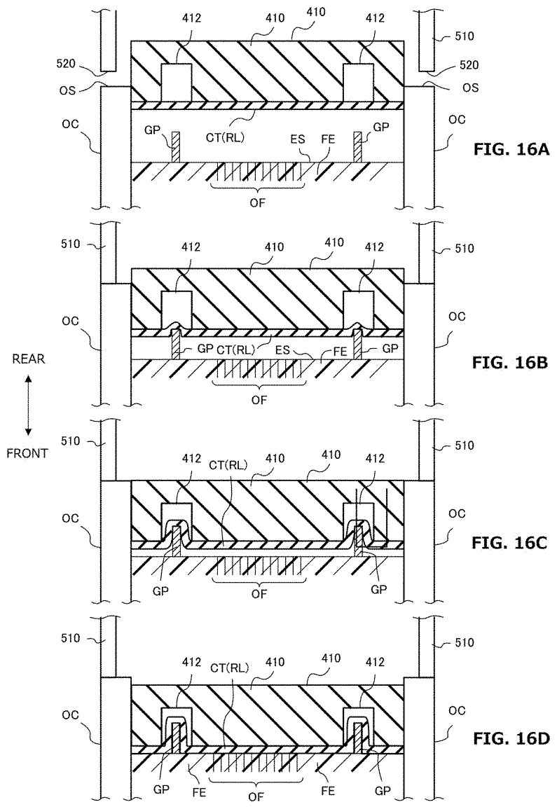

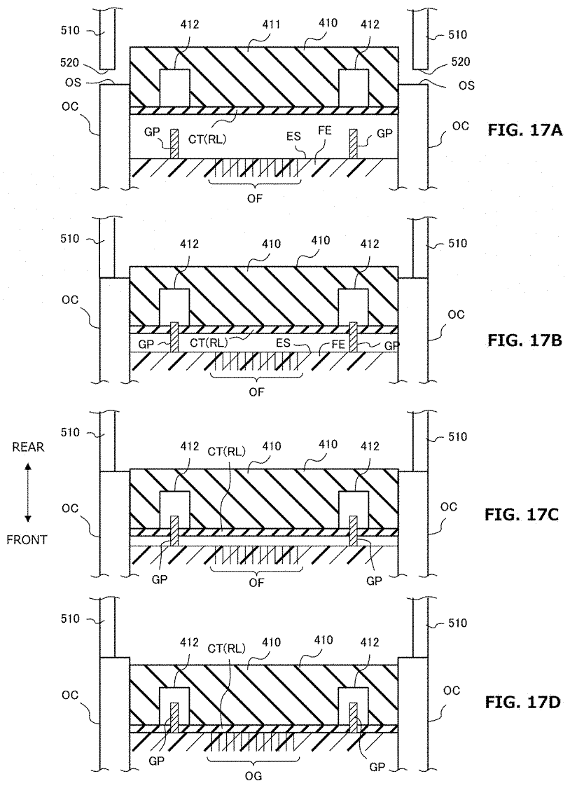

As will be described later, the adhesive layer may be deformed so as to follow the shapes of the guide pin and the accommodation hole when the guide pin is brought into contact with the adhesive layer and fitted into the accommodation hole provided in the end surface of the cleaning head distal end member (see FIG. 16) or the guide pin may penetrate the adhesive layer (see FIG. 17) when the guide pin is protruded from the end surface of the optical connector. In the case where the cleaning tape includes a base and an adhesive layer, the guide pin may penetrate the base and the adhesive layer may follow the guide pin. The adhesive layer is preferably deformed so as to follow the shapes of the guide pins and the accommodation holes from the viewpoint of the removability of contaminants adhering to the connector end surfaces and the guide pins. Since the adhesive layer follows the shapes of the guide pins and the accommodation holes, the area of the adhesive layer in contact with the guide pins is increased, and the cleaning area of the guide pins is increased, whereby the contaminant removal performance can be improved. Further, in a mode in which the cleaning tape is composed of the base material and the adhesive layer, the guide pin passes through the base material, and the adhesive layer follows the guide pin, the base material supports the adhesive layer, and therefore the optical connector end surface including the root of the guide pin is easily cleaned.

The cleaning tape may include a release film to protect the cleaning surface (the surface of the adhesive layer) of the cleaning tape from dirt and damage, such as during storage of the cleaner. The release film is laminated on the surface of the adhesive layer which is pressed against the end surface of the optical connector. The release film is released before the adhesive layer is pressed against the end surface of the optical connector. The cleaner of the present invention can include a mechanism for peeling and collecting the peeling film.

As the material for the release film, known materials may be used and are not particularly limited. The surface of the sheet-shaped material such as a resin film or paper on the resin layer side may be subjected to release treatment. The release treatment is not particularly limited, and examples thereof include a process for applying a release agent such as dimethylsiloxane.

### «<Cleaning Head»>

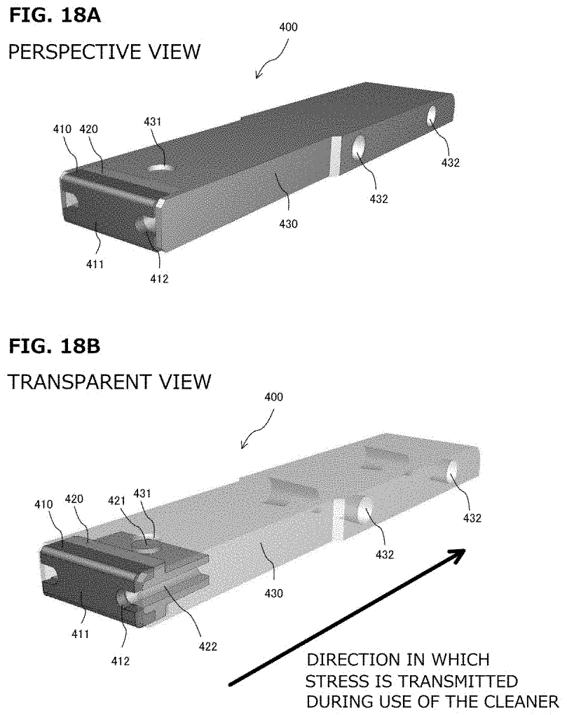

FIG. 18 illustrates an example of the cleaning head. The configuration and arrangement of the cleaning head will be described below with reference to FIG. 18. The cleaning head 400 includes a cleaning head distal end member 410 having a cleaning head end surface 411 for pressing the cleaning tape against the end surface of the optical connector when using the cleaner, a cleaning head buffering member 420 for supporting the cleaning head distal end member 410 and a cleaning head supporting member 430 for supporting the cleaning head distal end member 410 and/or the cleaning head buffering member 420.

In FIG. 18, the cleaning head end surface 411 is provided with an accommodation hole (A) 412 for accommodating a guide pin protruding from the end surface of the optical connector described later. The accommodation hole (A) 412 penetrates from the cleaning head end surface 411 toward the cleaning head buffering member 420. The cleaning head buffering member 420 is provided with an accommodation hole (B) 422 at a position facing the accommodation hole (A) 412. The accommodation hole (B) 422 penetrates from the surface of the cleaning head buffering member 420 in contact with the cleaning head distal end member 410 to the surface of the cleaning head buffering member 420 in contact with the cleaning head supporting member 430. As will be described later, the accommodation hole (A) 412 may or may not be penetrated as long as it can accommodate a guide pin protruding from the end surface of the optical connector when the cleaner is used and the cleaning tape can reach the end surface of the optical connector. The accommodation hole (A) 412 can be designed according to the distance between the cleaning head end surface 411 and the surface abutting against the cleaning head buffering member 420 of the cleaning head distal end member 413 and the length of the guide pin.

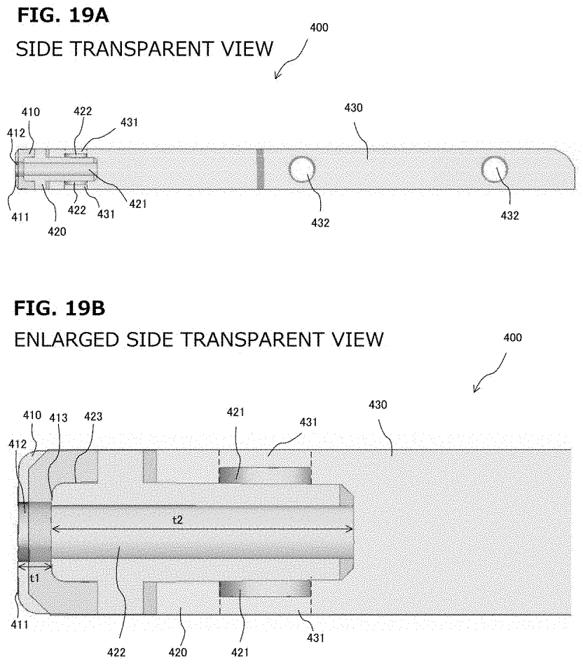

At least a part of the cleaning head buffering member 420 can be arranged in contact with the cleaning head distal end member 410 at a position where the cleaning head distal end member 410 is sandwiched between the end surface of the optical connector and the cleaning head buffering member 420 on the optical axis of the optical fiber of the optical connector when the cleaning tape is brought into contact (pressed) with the end surface of the optical connector (such as the end surface OP of the optical connector in FIG. 2) by the cleaning head (see FIG. 18B). With this arrangement, when the cleaning tape is pressed against the end surface of the optical connector (such as the end surface OP of the optical connector in FIG. 2) by the cleaning head, the stress acting on the cleaning head distal end member 410 is transmitted to at least a part of the cleaning head buffering member 420 via the cleaning head distal end member 410 (transmitted in the direction in which the stress in FIG. 19B acts). At this time, since a part of the cleaning head buffering member 420 absorbs stress and is deformed, it is possible to obtain a cleaner which exhibits excellent contaminant removal properties even for the end surfaces of various optical connectors, and further, the above-described optical connector end surface and optical fiber made of resin are hardly damaged, and which has good tape conveyance properties.

The cleaning head distal end member 410 and/or the cleaning head buffering member 420 may be supported by a cleaning head supporting member 430. At least a part of the cleaning head support member 430 can be arranged in contact with a part of the cleaning head buffering member 420 at a position where the end surface of the optical connector and the cleaning head support member 430 sandwich a part of the cleaning head end distal member 410 and the cleaning head buffering member 420 on the optical axis of the optical fiber of the optical connector when the cleaning tape is pressed against the end surface of the optical connector. With this arrangement, when the cleaning tape is pressed against the end surface of the optical connector (such as the end surface OP of the optical connector in FIG. 2) by the cleaning head, the stress acting on the cleaning head end distal member 410 is transmitted to the cleaning head support member 430 via the cleaning head distal end member 410 and the cleaning head buffering member 420. At this time, although a part of the cleaning head buffering member 420 absorbs the stress and is deformed, the harder cleaning head support member 430 limits the deformation of the cleaning head buffering member 420 to a certain range, so that the cleaning head buffering member 420 is not excessively deformed and the displacement of the position of the cleaning head distal end member 410 can also be limited. By doing so, it is possible to prevent the breakage of the guide pin, and it is possible to make the tape conveyance property excellent.

The cleaning head distal end member 410 can be a swinging structure by enabling the cleaning head distal end member 410 and/or the cleaning head buffering member 420 to operate. The swinging structure is not particularly limited, and may be a known structure. As the swinging structure, for example, the cleaning head distal end member 410 can be operated by deforming the cleaning head buffering member 420. In this case, if E1 of the cleaning head buffering member 420 is 1 MPa or less, the cleaning head buffering member 420 has sufficient flexibility and can have a structure in which the swinging effect is easily obtained.

### «Cleaning Head Distal End Member»

The cleaning head distal end member 410 according to the present invention includes a cleaning head end surface 411 for pressing the cleaning tape against the end surface of the optical connector when the cleaner is used. The cleaning head end surface 411 has a size and a shape corresponding to the end surface of the optical connector (for example, an end surface ES of a ferrule FE described later).

The cleaning head distal end member 410 preferably has a sufficient storage elastic modulus and thickness (t1 in FIG. 19B) in order to provide sufficient contaminant removal performance when the cleaning tape is brought into contact with the end surface of the optical connector, prevent damage to the end surface of the optical connector and the optical fiber made of resin, and improve the tape conveyance performance.

The storage elastic modulus E2 of the cleaning head distal end member 410 at 40° C. is not particularly limited as long as it is higher than the storage elastic modulus E1 of the cleaning head buffering member 420 at 40° C., but can be set to 200MPa or more, for example. The upper limit of E2 is not particularly limited, but may be, for example, 3000 MPa or less, and is preferably 2000 MPa or less, and more preferably 1000 MPa or less, from the viewpoint that the end surface of the optical connector and the optical fiber made of resin are hardly damaged. When the storage elastic modulus E2 at 40° C. is in such a range, it is possible to obtain a cleaner that exhibits excellent contaminant removal properties even for the end surfaces of various optical connectors, and further, the optical connector end surface and the optical fiber made of resin described above are hardly damaged, and that has good tape conveyance properties.

The thickness of the cleaning head distal end member 410 in the front-rear direction (for example, t1 in FIG. 19B) is not particularly limited, but may be, for example, 0.1 mm or more, preferably 0.3 mm or more, and more preferably 0.5 mm or more. The upper limit of the thickness of the cleaning head distal end member in the front-rear direction is not particularly limited, but can be set to, for example, 3 mm or less because the cleaner of the present invention is portable. Here, the thickness of the cleaning head distal end member 410 in the front-rear direction means the shortest length (for example, t1 in FIG. 19B) among the lengths on the optical axis of the optical fiber of the optical connector from a point on the surface of the cleaning head end surface 411 to a point abutting on the cleaning head buffering member 420.

The cleaner of the present invention is also dependent on the storage elastic modulus E1 of the cleaning head buffering member at 40° C. in order to have sufficient contaminant removal performance when it abuts against the end surface of the optical connector during use of the cleaner, make the end surface of the optical connector and the optical fiber made of resin difficult to be damaged, and further to make the tape conveyance property to be described later good. In the cleaner of the present invention, E2 should be larger than E1, but by setting the ratio of E2 to E1 (E2/E1) to 500 or more, it is possible to show further excellent contaminant removal properties even for the end surfaces of various optical connectors.

The cleaning head distal end member is not particularly limited as long as E2 is within the above-described range, and metal, ceramic, glass, resin, rubber, or the like can be used. These can be used alone or in combination of multiple. Among these, resin and rubber are preferable in that the end surface of the optical connector and the optical fiber are less likely to be damaged. In addition, of the resin and the rubber, a resin having a glass transition temperature of 10° C. or higher is more preferable from the viewpoint of the tape conveyance property. In the case where it is necessary to reduce the thickness of the cleaning head distal end member, a material having a high storage elastic modulus such as metal or ceramics may be used.

### «Cleaning Head End Surface»

The cleaning head end surface is not particularly limited, and may have a planar shape or a curved shape.

In the case where the cleaning head end surface is a plane, the normal direction of the cleaning head end surface may be parallel (relationship of 180°) to the optical axis direction of the optical fiber of the optical connector, or may be inclined from parallel (relationship of 180°) to the optical axis direction thereof. The end surface of the optical connector may generally be inclined from 5 to 20 degrees relative to the optical axis of the optical fiber. When the end surface of such an optical connector is cleaned, the cleaner of the present invention can incline the normal direction of the end surface of the cleaning head so that the normal direction of the end surface of the optical connector and the inclination of the optical fiber in the optical axis direction are 180°.

By doing so, the area where the end surface of the cleaning head and the end surface of the optical connector abut against each other is increased, and therefore, it is possible to make the removability of the contaminants excellent. That is, the cleaner of the present invention is preferably configured such that the end surface of the cleaning head of the cleaner and the end surface of the optical connector can face each other and abut against each other. That is, the normal direction of the end surface of the optical connector and the normal direction of the end surface of the cleaning head are in a relationship of 180°, and are preferably contactable.

In the cleaner of the present invention, even when the inclination angle of the end surface of the optical connector with respect to the optical axis of the optical fiber and the inclination of the cleaning head do not coincide with each other, the cleaning head distal end member can be displaced so that the end surface of the cleaning head and the end surface of the optical connector can be opposed to each other by using a material having a low E1 as the cleaning head buffering member. Such E1 is not particularly limited, but may be, for example, 0.5 to 1.0 MPa, and 0.1 to 0.7 Mpa is preferable.

The end surface of the cleaning head is not limited to a plane, but may be a spherical surface, an elliptical spherical surface, or another curved surface. When the cleaning head end surface is a spherical surface, an elliptical spherical surface, or another curved surface, the cleaning head end surface can have at least one maximum point. The maximum point can be located on the optical axis of at least one optical fiber provided on the end surface of the optical connector when the cleaning tape abuts the end surface. By doing so, the area where the end surface of the cleaning head and the end surface of the optical connector abut against each other is increased, and therefore, it is possible to make the removability of contaminants excellent. In addition, by further having the head swing structure, it becomes easy to further follow the inclination of the end surface of the optical connector, and it is possible to further improve the removability of contaminants on the end surface of the optical connector.

### (Accommodation Hole (A))

Two accommodation holes (A) for accommodating two guide pins protruding from the end surface of the optical connector may be formed in the end surface of the cleaning head. By forming the accommodation holes (A), when the guide pins are protruded from the end surface of the optical connector, the cleaning tape can reach the base of the guide pins, and the dust in the vicinity of the base of the guide pins can be removed accurately. The removal of dust adhered to the vicinity of the root of the guide pin will be described later. However, when a wiping type cleaner is used, it is necessary to make the width of the cleaning tape narrower than the width between the guide pins.

The accommodation hole (A) may or may not penetrate the cleaning head distal end member. That is, the depth of the accommodation hole (A) is not particularly limited. The depth of the accommodation hole (A) can be designed according to the length of the guide pin and the thickness of the cleaning head distal end member in the front-rear direction. In the case where the guide pin penetrates the cleaning head distal end member when the end surface of the optical connector abuts against the cleaning tape, the cleaning head buffering member can be provided with an accommodation hole (B) or a concave part (b) at a position facing the accommodation hole (A) of the cleaning head buffering member.

The cross-sectional shape and size of the accommodation hole (A) in the cleaning head end surface are not particularly limited as long as the guide pin can be accommodated. The cross-sectional shape of the accommodation hole (A) on the cleaning head end surface can be freely designed in consideration of the shape of the guide pin such as circular, elliptical, or polygonal. Since the cross-sectional shape of the guide pin is generally circular, the cross-sectional shape of the accommodation hole (A) in the cleaning head end surface is preferably circular. In particular, in the case where the cleaning tape follows the shapes of the guide pin and the accommodation hole (A) when the guide pin is fitted into the accommodation hole (A), the cross-sectional shape of the accommodation hole (A) at the cleaning head end surface is preferably circular. When the guide pin is fitted into the accommodation hole (A), if the cross-sectional shape of the accommodation hole (A) at the cleaning head end surface is circular, the cleaning tape is subjected to more uniform stress at the edge of the accommodation hole (A), and therefore the shape of the guide pin and the accommodation hole (A) can be easily followed without damaging the cleaning tape.

### «Cleaning Head Buffering Member»

The cleaning head 400 according to the present invention includes the cleaning head buffering member 420.

At least a part of the cleaning head buffering member 420 is in contact with the rear side of the cleaning head distal end member 410, and is arranged to support the cleaning head distal end member 410. Further, the cleaning head buffering member 420 is disposed in contact with a cleaning head supporting member 430 disposed on the rear side. With this arrangement, when the cleaning tape is pressed against the end surface of the optical connector by being pressed against the cleaning head during use of the cleaner of the present invention, the stress generated at the end surface of the cleaning head is transmitted to the rear side via the cleaning head distal end member, that is, is transmitted to the cleaning head buffering member supporting the cleaning head distal end member, and is absorbed by the cleaning head buffering member.

The storage elastic modulus E1 of the cleaning head buffering member at 40° C. is not particularly limited as long as it is lower than E2 and E3, but may be, for example, 0.5 to 1.0 MPa, and preferably 0.1 to 0.7 MPa. The ratio of E2 to E1 (E2/E1) is not particularly limited as long as the effect of the present invention is not inhibited, but may be, for example, 500 or more, and preferably 1000. When the storage elastic modulus E1 of the cleaning head buffering member at 40° C. and the storage elastic modulus E2 of the cleaning head distal end member at 40° C. are in such a range, the cleaning head buffering member exhibits excellent contaminant removal properties even for the end surfaces of various optical connectors, and further, the optical connector end surfaces and the optical fibers made of resin are hardly damaged, and a cleaner having good tape conveyance properties can be obtained.

The material of the cleaning head buffering member is not particularly limited as long as the storage elastic modulus E1 is within the above-described range, and for example, resin, rubber, or the like can be used. These can be used alone or in combination of multiple.

The shape of the cleaning head buffering member 420 is not particularly limited, and may be any shape or size capable of supporting the cleaning head distal end member 410. The shape of the part of the cleaning head buffering member 420 that abuts against the rear side of the cleaning head distal end member 410 is not particularly limited, but may be a cylindrical shape, an elliptic cylindrical shape, a polygonal columnar shape, or the like. By forming the shape of the part of the cleaning head buffering member 420 that abuts on the rear side of the cleaning head distal end member 410 to be cylindrical, elliptic cylindrical, polygonal columnar, or the like, the following property with respect to the inclination or the like of the end surface of the optical connector can be made excellent because the anisotropy is small compared to a spring or the like, that is, the degree of freedom in the direction of deformation is high.

In addition, the tape conveyance property can be improved. Furthermore, since the structure is simple, the design can be easily performed and the manufacturing cost can be reduced.

The thickness of a part of the cleaning head buffering member 420, i.e., the thickness in the front-rear direction of a part abutting on the rear side of the cleaning head distal end member 410 (for example, t2 in FIG. 19B) is not particularly limited, but is, for example, 0.5 mm or more, and preferably 2 mm or more. The upper limit of the thickness is not particularly limited, but may be, for example, 20 mm or less. Here, the thickness of the part of the cleaning head buffering member 420 abutting on the rear side of the cleaning head distal end member 410 in the front-rear direction indicates the length of a point where the cleaning head buffering member abuts on the cleaning head distal end member 410 and a point where the cleaning head buffering member abuts on a cleaning head supporting member described later (for example, t2 in FIG. 19B) on the optical axis of the optical fiber provided on the end surface of the optical connector when the cleaning tape abuts on the end surface of the optical connector in the cleaning head buffering member 420.

The cleaning head buffering member 420 can support the cleaning head distal end member 410 using known methods such as fasteners. In FIGS. 18 and 19, the cleaning head distal end member 410 and the cleaning head buffering member 420 are shown as examples in which a concave structure 413 provided in the cleaning head distal end member 410 and a convex structure 423 provided in the cleaning head buffering member 420 are fitted and fixed and supported.

«Accommodation Hole (B) or Concave Part (b)»

The cleaning head buffering member can be provided with an accommodation hole (B) or a concave part (b) capable of accommodating the guide pin at a position corresponding to the guide pin that is protruded from the end surface of the optical connector. By providing the accommodation hole (B) or the concave part (b), the cleaning tape can reach the root of the guide pin, and the dust in the vicinity of the root of the guide pin can be removed accurately. The removal of dust adhered to the vicinity of the root of the guide pin will be described later.

In the present application, when the guide pin penetrates the cleaning head distal end member and reaches the cleaning head buffering member, the concave part provided in the cleaning head buffering member has a depth that fits to the side peripheral surface of the guide pin as the accommodation hole (B), and a concave part having a depth that does not reach the side peripheral surface of the guide pin as the concave part (b).

The accommodation hole (B) may or may not penetrate the cleaning head buffering member. In the case where the guide pin penetrates the cleaning head buffering member and reaches the cleaning head supporting member, the accommodation hole (B) can be designed according to the length of the guide pin, the thickness of the cleaning head distal end member in the front-rear direction, and the thickness of the cleaning head buffering member in the front-rear direction. In the case where the guide pin penetrates the cleaning head distal end member and the cleaning head buffering member when the end surface of the optical connector abuts against the cleaning tape, the cleaning head supporting member can be provided with the accommodation hole \textcircled{C} or the concave pa\textcircled{C}(c) at a position facing the accommodation hole (B) of the cleaning head buffering member. The housing hole (C) or the concave part (c) will be described later.

The cross-sectional shape and size of the accommodation hole (B) and the concave part (b) in a plane parallel to the cleaning head end surface are not particularly limited as long as the guide pin can be accommodated. The cross-sectional shapes of the accommodation hole (B) and the concave part (b) in a plane parallel to the cleaning head end surface can be freely designed in consideration of the cross-sectional shapes of the guide pins such as circular, elliptical, and polygonal. In general, since the cross- sectional shape of the guide pin in a plane parallel to the cleaning head end surface is circular, the cross-sectional shape of the accommodation hole (B) and the concave part (b) in the cleaning head end surface is preferably circular.

The cross-sectional shapes of the accommodation hole (B) and the concave part (b) may be the same as or different from the cross-sectional shape of the accommodation hole (A).

«Cleaning Head Supporting Member»The cleaning head 400 according to the present invention includes a cleaning head supporting member 430. The shape of the cleaning head supporting member 430 is not particularly limited, and may have a shape and a size capable of supporting the cleaning head distal end member and/or the cleaning head buffering member.

The cleaning head supporting member 430 can support the cleaning head distal end member 410 and/or the cleaning head buffering member 420, as described above. At least a part of the cleaning head supporting member 430 can be arranged in contact with a part of the cleaning head buffering member 420 at a position where the end surface of the optical connector and the cleaning head supporting member 430 sandwich a part of the cleaning head distal end member 410 and the cleaning head buffering member 420 on the optical axis of the optical fiber of the optical connector when the cleaning tape is pressed against the end surface of the optical connector. With this arrangement, when the cleaning tape is pressed against the end surface of the optical connector (such as the end surface OP of the optical connector in FIG. 2) by the cleaning head, the stress acting on the cleaning head distal end member 410 is transmitted to the cleaning head supporting member 430 via the cleaning head distal end member 410 and the cleaning head buffering member 420. At this time, although a part of the cleaning head buffering member 420 absorbs the stress and is deformed, the harder cleaning head supporting member 430 limits the deformation of the cleaning head buffering member 420 to a certain range, so that the cleaning head distal end member 410 is not excessively deformed and the displacement of the position can be limited. By doing so, it is possible to prevent the breakage of the guide pin, and it is possible to make the tape conveyance property excellent.

The cleaning head supporting member 430 can support the cleaning head distal end member 410 and/or the cleaning head cushioning member 420 using known methods such as fasteners. In FIGS. 18 and 19, the cleaning head buffering member 420 and the cleaning head supporting member 430 are fixed and supported by fitting a convex part 422 provided in the cleaning head buffering member 420 and a hole part 431 provided in the cleaning head supporting member 430.

The cleaning head supporting member 430 may be integrated with the cleaner main body or may be separate from the main body. When the cleaning head supporting member 430 is separate from the main body, it may have a shape that allows the cleaner head to be connected to the cleaner main body directly or via another component. The cleaning head supporting member 430 can be connected to the cleaner body by using a known method such as a fastener.

The storage elastic modulus E3 of the cleaning head supporting member at 40° C. is not particularly limited as long as it is higher than E1, but may be, for example, 200 MPa or more. The upper limit of E3 is not particularly limited, but may be, for example, 1000 Mpa.

By setting the ratio of E3 to the storage elastic modulus E1 of the cleaning head buffering member at 40° C. (i.e., E3/E1) to 500 or more, the cleaning head can be fixed at a fixed position when the cleaning head buffering member absorbs stress generated at the end surface of the cleaning head when the cleaning head buffering member contacts the end surface of the optical connector during use of the cleaner. Accordingly, the cleaning head 400 can be held at a fixed position with respect to the cleaner main body and the like, and the tape conveying property of the cleaning tape supplied to the cleaning head end surface of the cleaning head 400 can be improved. Further, the cleaning tape can be pressed against the end surface of the ferrule for the optical connector with a constant force, and the end surface of the optical connector and the dust of the guide pin can be stably removed without depending on the skill of the operator.

The magnitude relationship between E3 and E2 is not particularly limited, and either one of them may be higher than the other, or may be the same. In the case where E3 and E2 are the same, it is possible to obtain a cleaner which exhibits better contaminant removal properties even for the end surfaces of various optical connectors, and which is further less likely to damage the end surfaces of the optical connectors and the optical fibers made of resin, and which has better tape conveyance properties. Further, when E2/E1 and E3/E1 are the same and are in the range of 550 to 4200, a cleaner can be obtained which exhibits further excellent contaminant removal properties even for the end surfaces of various optical connectors, and which is further excellent in tape conveyance properties because the end surfaces of the optical connectors and the optical fibers made of resin are not easily damaged.

The material of the cleaning head distal end member is not particularly limited as long as E3 is within the above-described range, and metal, ceramic, glass, resin, or the like can be used. These can be used alone or in combination of multiple. Among these, metal and resin are preferable from the viewpoint of being hardly broken, and resin is preferable from the viewpoint of being lightweight.

«Accommodation Hole (C) or Concave Part (c)»

In the case where the guide pin that is protruded from the end surface of the optical connector penetrates the cleaning head distal end member and the cleaning head buffering member, the cleaning head supporting member can be provided with the accommodation hole (C) or the concave part (c) at a position corresponding to the guide pin that penetrates the cleaning head distal end member and the cleaning head buffering member. By providing the accommodation hole (C) or the concave part (c), the cleaning tape can reach the root of the guide pin, and the dust in the vicinity of the root of the guide pin can be removed accurately. The removal of dust adhered to the vicinity of the root of the guide pin will be described later.

In the present application, when the guide pin penetrates the cleaning head distal end member and the cleaning head buffering member and reaches the cleaning head supporting member, the concave part provided in the cleaning head supporting member has a depth to be fitted to the side peripheral surface of the guide pin as the accommodation hole (C), and a depth not reaching the side peripheral surface of the guide pin as the concave part (c).

The accommodation hole (C) can be designed according to the length of the guide pin, the thickness of the cleaning head distal end member and the cleaning head buffering member in the front-rear direction, and the thickness of the cleaning head supporting member in the front-rear direction when the guide pin penetrates the cleaning head distal end member and the cleaning head buffering member and reaches the cleaning head supporting member.

The cross-sectional shape and size of the accommodation hole (C) and the concave part (c) in a plane parallel to the cleaning head end surface are not particularly limited as long as the guide pin can be accommodated. The cross-sectional shapes of the accommodation hole (C) and the concave part (c) in a plane parallel to the cleaning head end surface can be freely designed in consideration of the cross-sectional shapes of the guide pins such as circular, elliptical, and polygonal. In general, since the cross-sectional shape of the guide pin in a plane parallel to the cleaning head end surface is circular, the cross-sectional shape of the accommodation hole (C) and the concave part (c) in the cleaning head end surface is preferably circular.

The cross-sectional shapes of the accommodation hole (C) and the convex part (c) may be the same as or different from the cross-sectional shape of the accommodation hole (B).

### «<Tape Supply Mechanism»>

The cleaner of the present invention has a tape supply mechanism for supplying cleaning tape to the cleaning head.

The tape supply mechanism according to the present invention may be a known tape supply mechanism, and is not particularly limited. For example, the cleaning tape is supplied from a supply reel to the cleaning head by means of a rack, a ratchet gear, and the like, and is further wound around a take-up reel via a cleaning head distal end member and a cleaning head end surface.

### ««Embodiment of Cleaner»»

The cleaner of the embodiment example (shown in FIG. 1) and the operation of the cleaner of the embodiment example will be described in detail below. In the following embodiment example, a tape-fixing type cleaner, which is a preferred example of the present invention, will be described. The cleaner of the present invention is not limited to the present embodiment.

The cleaner (e.g., a cleaner 10 described later) of the embodiment example including:
a main body (e.g., a housing 100 described later) housing a supply holder (e.g., a supply reel 200 described later) configured to hold a cleaning tape (e.g., a cleaning tape CT described later, A cleaning tape (such as a cleaning tape CT to be described later, or hereinafter, may be referred to as a cleaning element) that has a contaminant-retainable layer (e.g., a resin layer RL described later) and can be supplied so as to clean an end surface (e.g., an end surface ES of a ferrule FE for an optical connector as described later) of an optical connector;
a cleaning head (e.g., a cleaning head 400 described later) configured to position the cleaning tape having been supplied from the main body and be held at a certain holding position with respect to the main body;
a controller (e.g., a take-up controller 500 described later) that can be engaged with the optical connector and can be displaced from a first position to a second position, which is different from the first position, with respect to the cleaning head while kept engaged with the optical connector; and
a tape supply mechanism (e.g., a rack 536 and a ratchet gear 322 described later) configured to transmit, to the cleaning tape, movement of displacing the controller from the first position to the second position to displace and then supply the cleaning tape to the cleaning head,
in which when the controller is positioned at the first position, the cleaning head is apart from the end surface of the optical connector,
while the controller is displaced from the first position to the second position, the tape supply mechanism causes the cleaning tape to be displaced, and
when the controller is positioned at the second position, the cleaning head comes into contact with the end surface of the optical connector.

The tape supply mechanism includes a tape supply holder, and holds the cleaning tape so that the cleaning tape can be supplied (delivered).

The cleaning head is separated from the main body and held in a certain holding position with respect to the main body. The cleaning head is held in a fixed position with respect to the main body. The cleaning tape, which is supplied from the main body, is positioned in the cleaning head. This causes almost no change in the relative position or distance between the cleaning head and the main body, during cleaning work. Accordingly, while the cleaner (e.g., the main body, the cleaning head) is kept at a certain attitude, the cleaning tape can be pressed on the end surface of the optical connector. This makes it possible to accurately transfer a contaminant from the end surface of the optical connector to the adhesive layer.

The controller can be engaged with the optical connector. For instance, a worker may bring the cleaner closer to the optical connector to engage the controller with the optical connector. The controller can be displaced from the first position to the second position with respect to the cleaning head. The first position and the second position are apart from each other. The controller may be displaced relative to the cleaning head and is not necessarily displaced relative to the optical connector.

The tape supply mechanism transmits, to the cleaning tape, movement of displacing the controller from the first position to the second position. The cleaning tape is displaced by the movement transmitted and then supplied to the cleaning head.

When the controller is positioned at the first position, the cleaning head is apart from the end surface of the optical connector. That is, when the controller is located at the first position, the cleaning tape is not yet in a state of cleaning the optical connector.

While the controller is displaced from the first position to the second position, the cleaner is displaced by the supply mechanism. The cleaning tape is displaced while the controller is moved from the first position to the second position, so that a clean cleaning tape can be supplied to the cleaning head.

When the controller is located at the second position, the cleaning head comes into contact with the end surface of the optical connector, so that a clean cleaning tape can be brought into contact with the end surface of the optical connector to clean the end surface of the optical connector.

That is, when the controller is located at the first position, the cleaning head of the cleaner according to the first embodiment is apart from the end surface of the optical connector; while the controller is displaced from the first position to the second position, the cleaning tape is displaced; and when the controller is located at the second position, the cleaning head comes into contact with the end surface of the optical connector.

When the controller is displaced, movement of the controller is transmitted to the cleaning tape via the supply mechanism, and the cleaning tape is thus supplied from the main body to the cleaning head.

Further, when the controller is located at the first position, the cleaning head may be apart from the end surface of the optical connector; when the controller is located at the second position, the cleaning head may come into contact with the end surface of the optical connector; and while the controller is displaced from the first position to the second position, the cleaning head may gradually become closer to the end surface of the connector.

### «Configuration of the End Surface Cleaner of Optical Connector»

Hereinafter, the configuration of the cleaner of the present invention will be described below with reference to the drawings.

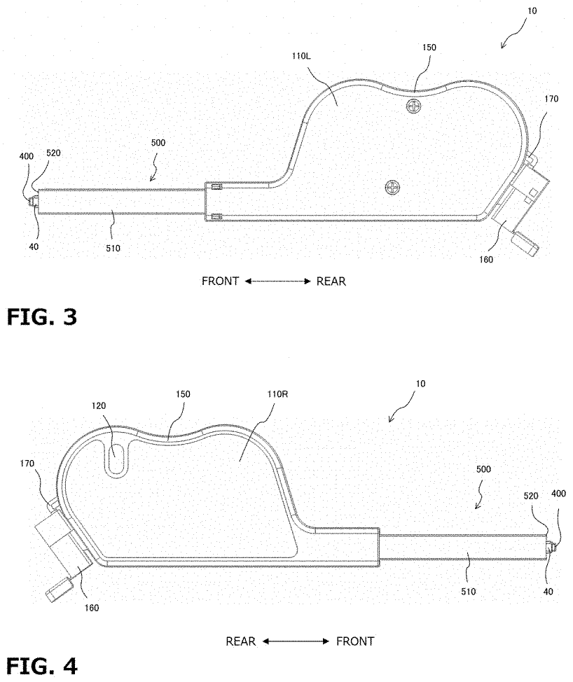

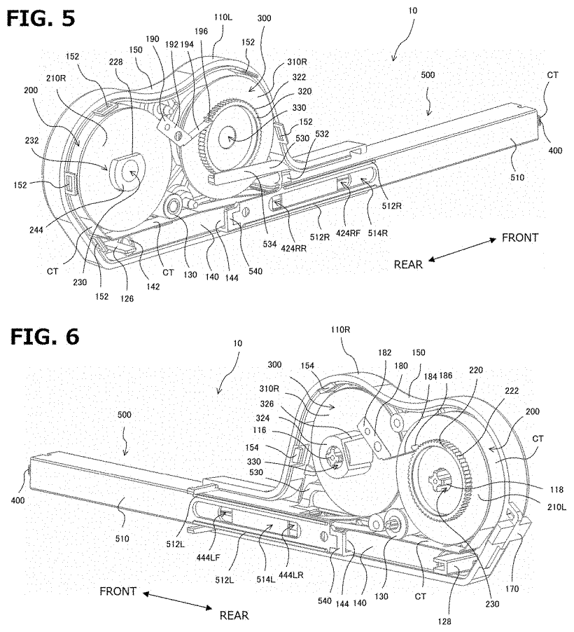

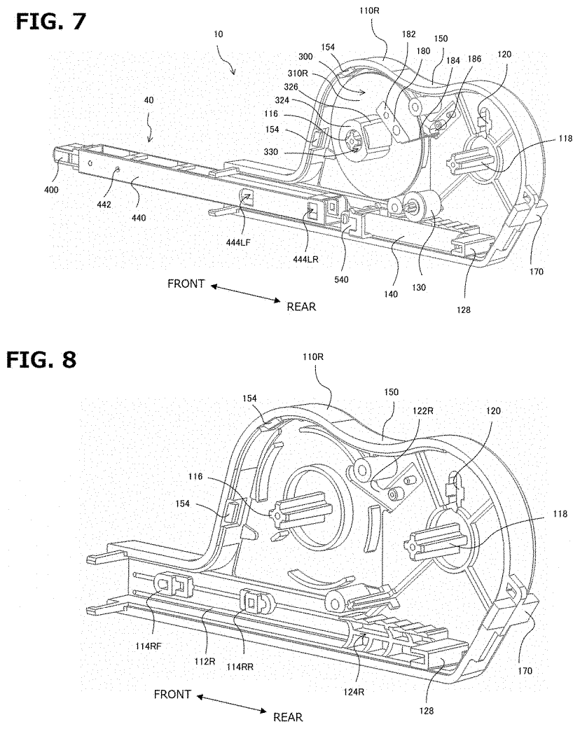

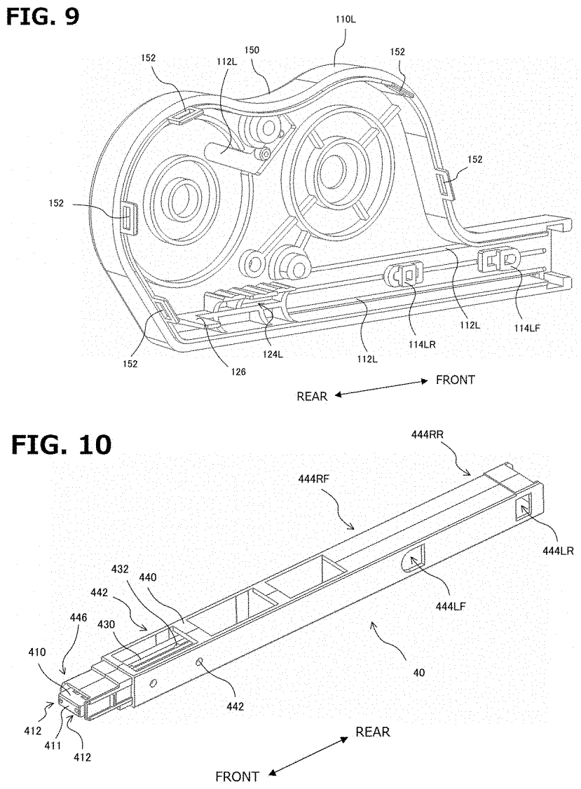

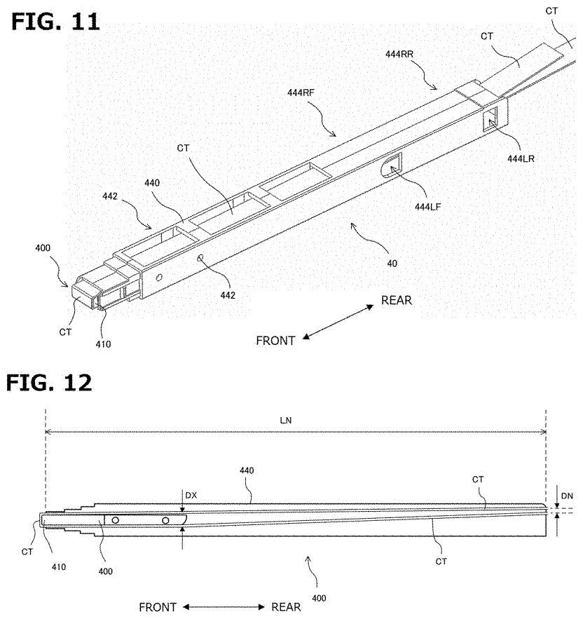

FIG. 1 is a perspective view showing the overall outline of a cleaner 10 according to an embodiment of the invention. FIG. 2 is a perspective view showing the overall outline of the cleaner 10 in this embodiment and an optical connector OC. FIG. 3 is a side view showing the left side surface of the cleaner 10 in this embodiment. FIG. 4 is a side view showing the right side surface of the cleaner 10 in this embodiment. FIG. 5 is a perspective view showing a state in which a right housing 110R of the cleaner 10 in this embodiment is removed. FIG. 6 is a perspective view showing a state in which a left housing 110L of the cleaner 10 in this embodiment is removed. FIG. 7 is a perspective view showing a state in which a supply reel 200 and a take-up reel 300 of the cleaner 10 in this embodiment are removed. FIG. 8 is a perspective view showing the configuration of the right housing 110R of the cleaner 10 in this embodiment. FIG. 9 is a perspective view showing the configuration of the left housing 110L of the cleaner 10 in this embodiment. FIG. 10 is a perspective view showing the configuration of a head section 40 (a cleaning head 400 and a head holder 440) of the cleaner 10 in this embodiment. FIG. 11 is a perspective view showing a path of a cleaning tape CT in the head section 40 of the cleaner 10 in this embodiment. Note that in FIGS. 5 to 9, a cap 160 is omitted for convenience.

### ««Cleaner 10»»

The cleaner 10 is a cleaning tool (cleaning instrument) for an optical connector to clean an end surface of a ferrule for the optical connector by using a cleaning tape.

«<Direction»>The directions used herein will be described (see FIGS. 1 and 2).

### <Front/Rear/Longitudinal>

The side on or the direction in which the cleaning head 400 of the cleaner 10 is located is set to the front side or the front direction, and the side on or the direction in which the housing 100 is located is set to the rear side or the rear direction. Note that the front-rear direction may be referred to as the longitudinal direction of the head section 400.

### <Right/Left>

The right side or direction when viewed from the rear side to the front side is referred to as the right side or the right direction, and the left side or the direction when viewed from the rear side to the front side is referred to as the left side.

### <Lower/Upper>

Further, the side on or the direction in which the coil spring 140 is located is referred to as the lower side, lower direction, or lower portion, and the side on or the direction in which the supply reel 200 or the take-up reel 300 is located is referred to as the upper side, upper direction, or upper portion.

### <Upstream/Downstream>

The side on which the cleaning tape CT is sent out and supplied is referred to as the upstream side, and the side on which the cleaning tape CT is taken up is referred to as the downstream side. The supply reel 200 described later is located upstream, and the take-up reel 300 is located downstream.

### <Cleaning Tape CT>

The cleaning tape CT is long and flexible. In the embodiment, the cleaning tape CT has an adhesive layer, and the adhesive layer comes into contact with the connector end surface and the guide pin GP, whereby dirt such as dust can be more efficiently removed. The cleaning tape CT has, for instance, an integrally continuous shape such as a tape-like shape or a thread-like shape.

The cleaning tape CT is sent to the cleaning head, and is brought into contact with the end surface ES and the guide pin GP of the ferrule FE for the optical connector on the cleaning head. At this time, the adhesive layer is layered on a surface of the cleaning tape in contact with the end surface of the optical connector. Further, the release film is laminated on the adhesive layer. The release film is peeled off and excluded from the cleaning tape CT before the cleaning tape CT reaches the cleaning head.

### ««Configuration of Cleaner 10»»

The cleaner 10 mainly includes a housing 100, a supply reel 200, a take-up reel 300, a head section 40, and a take-up controller 500. These housing 100, supply reel 200, take-up reel 300, head section 40, and take-up controller 500 are formed of, for instance, ABS resin (acrylonitrile/butadiene/styrene copolymer synthetic resin) or POM (polyacetal) resin.

### «<Housing 100»>

The housing 100 rotatably holds the supply reel 200 and the take-up reel 300. The housing 100 houses the supply reel 200 and the take-up reel 300 along the front-rear direction. In the housing 100, the take-up reel 300 is located on the front side and the supply reel 200 is located on the rear side. The housing 100 has an elongated shape as a whole.

The housing 100 has a recess 150 in the region between the supply reel 200 and the take-up reel 300, which makes it easy for a worker's fingers to engage and allows the worker to operate accurately.

The housing 100 has a right housing 110R and a left housing 110L. The housing that includes a right side portion of the housing 100 is the right housing, and the housing that includes a left side portion of the housing 100 is the left housing. The right housing 110R has a locking claw 154 and the left housing 110L has a locking hole 152. The outer shape of the right housing 110R and the outer shape of the left housing 110L has an approximately linearly symmetric shape. The right housing 110R faces the left housing 110L and the locking claw of the right housing 110R is locked into the locking hole of the left housing 110L, so that the housing 100 can be integrated.

### «Right Housing 110R»

The right housing 110R is a housing that includes, as a component, the right side portion of the housing 100.

### <Guide Groove 112R>

Two guide grooves 112R are provided at a lower part of the right housing 110R. The guide grooves 112R are engaged with the guide ridge 512R formed on the right side surface of the take-up controller 500, so that the take-up controller 500 can be moved while being guided in the front-rear direction.

### <Stopper 114RF and Stopper 114RR>

The stopper 114RF is located forwardly of a lower part of the right housing 110R, and the stopper 114RR is located behind the lower part of the right housing 110R.

The stopper 114RF defines the maximum front position MF of the take-up controller 500, and the stopper 114RR defines the maximum rear position MR of the take-up controller 500.

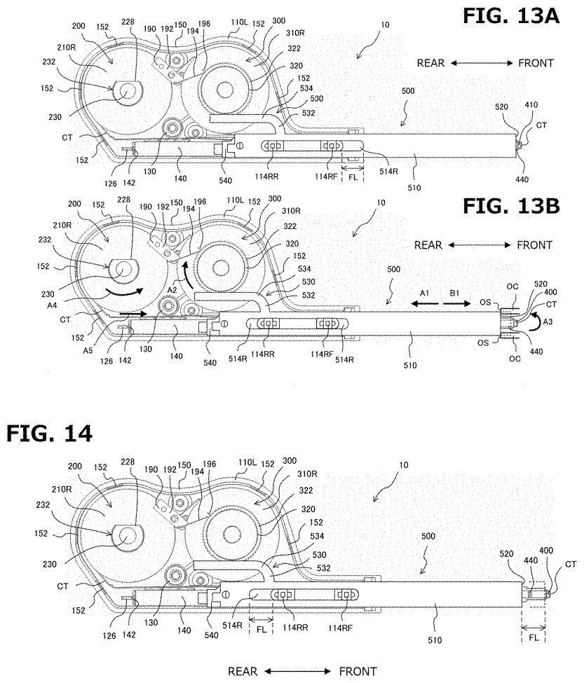

The stopper 114RF and the stopper 114RR are engaged with the movement control hole 514R formed on the right side of the take-up controller 500 to stop the take-up controller 500 at the maximum front position MF (the state shown in FIG. 13A described later) or stop the take-up controller 500 at the maximum rear position MR (the state shown in FIG. 14 described later).

Further, the stopper 114RF is engaged with the front locking hole 444RF formed on the right side surface of the head holder 440, and the stopper 114RR is engaged with the rear locking hole 424RR formed on the right side surface of the head holder 440. In this way, the head holder 440 is locked on the housing 100.

<Front Protrusion 116 and Rear Protrusion 118 (Rotatably Held)>

The front protrusion 116 and the rear protrusion 118 are formed protruding in the right direction. The through-hole 330 for the take-up reel 300 is formed on the front protrusion 116, and the front protrusion 116 rotatably supports the take-up reel 300. The rear protrusion 118 is inserted into a through-hole 230 of the supply reel 200, and the rear protrusion 118 rotatably supports the supply reel 200.

### <Remaining Amount-Checking Window 120>

The remaining amount-checking window 120 is a through-hole for visually recognizing the amount (remaining amount) of the remaining cleaning tape CT wound around the supply reel 200. A worker can check the remaining amount of the cleaning tape CT and proceed with the operation.

### <Pawl Holder 122R>

The pawl holder 122R is formed like a recess (like a cavity), and can accommodate and hold a fixing end 192 of a take-up reel pawl 190. The fixing end 192 of a take-up reel pawl 190 is fixed to the pawl holder 122R.

### <Spring Holder 124R>

The spring holder 124R faces a spring holder 124L, which will be described later, and holds the coil spring 140 in a stretchable manner. In particular, even when the coil spring 140 is in a contracted state, the shape of the coil spring 140 can be kept like a cylinder and the coil spring 140 can be held stably.

### <Spring Stopper Housing 128>

The spring stopper housing 128 houses a spring stopper 126, which will be described later, formed in the left housing 110L. The spring stopper 126 is covered by the spring stopper housing 128 to be able to prevent a fixing end 142 of the coil spring 140 locked to the spring stopper 126 from coming off from the spring stopper 126.

### «Left Housing 110 »

### <Guide Groove 112L>

Two guide grooves 112L are provided at a lower part of the left housing 110L. The guide grooves 112L are engaged with the guide ridge 512L formed on the left side surface of the take-up controller 500, so that the take-up controller 500 can be moved while being guided in the front-rear direction.

### <Stopper 114LF and Stopper 114LR>

The stopper 114LF is located forwardly of a lower part of the left housing 110L, and the stopper 114LR is located rearward the lower part of the left housing 110L. Like the stoppers 114RF and 114RR, they define the maximum front position MF and the maximum rear position MR of the take-up controller 500. Specifically, the stopper 114LF defines the maximum front position MF of the take-up controller 500, and the stopper 114LR defines the maximum rear position MR of the take-up controller 500.

The stopper 114LF and the stopper 114LR are engaged with the movement control hole 514L formed on the left side of the take-up controller 500 to stop the take-up controller 500 at the maximum front position MF or stop the take-up controller 500 at the maximum rear position MR.

Further, the stopper 114LF is engaged with the front locking hole 444LF formed on the left side surface of the head holder 440, and the stopper 114LR is engaged with the rear locking hole 444LR formed on the left side surface of the head holder 440. In this way, the head holder 440 is locked on the housing 100.

### <Pawl Holder 122L>

The pawl holder 122L is formed like a recess (like a cavity), and can accommodate and hold a fixing end 182 of the supply reel pawl 180. The fixing end 182 of the supply reel pawl 180 is fixed to the pawl holder 122L.

### <Spring Holder 124L>

As described above, the spring holder 124L faces the spring holder 124R, and holds the coil spring 140 in a stretchable manner.

### <Spring Stopper 126>

The spring stopper 126 locks the fixing end 142 of the coil spring 140. The spring stopper 126 can stably hold the coil spring 140 even when the coil spring 140 expands and contracts. The spring stopper 126 is housed in the spring stopper housing 128 formed at the right housing 110R described above. This makes it possible to prevent the fixing end 142 of the coil spring 140 from coming off from the spring stopper 126.

### «Cleaner Guide Roller 130 »

The cleaner guide roller 130 is rotatably provided between the supply reel 200 and the take-up reel 300. The cleaner guide roller 130 has a substantially cylindrical shape. The cleaner guide roller 130 abuts on the cleaning tape CT to bend the cleaning tape CT and change the transfer direction of the cleaning tape CT. Specifically, the direction of the cleaning tape CT sent out from the supply reel 200 can be changed in a certain direction to guide the cleaning tape CT toward the cleaning head 400. The cleaning tape CT may be adjusted and directed in a certain direction to reliably send the cleaning tape CT toward the cleaning head 400 regardless of the remaining amount of the cleaning tape CT wound around the supply reel 200.

### «Coil Spring 140»

The coil spring 140 is a coil-shaped spring, and is formed in a stretchable manner. Note that in each figure, the coil spring 140 is shown in a columnar shape for convenience. The coil spring 140 generates an urging force in response to the state of expansion or contraction. The coil spring 140 has two ends, the fixing end 142 and a moving end 144. The fixing end 142 is locked to the spring stopper 126 of the left housing 110L. The moving end 144 is engaged with the coil spring pressing portion 540 of the take-up controller 500. When the take-up controller 500 moves to the rear side, the coil spring 140 contracts, and when the take-up controller 500 moves to the front side, the coil spring 140 expands. The coil spring 140 applies an urging force to the take-up controller 500.

### «Supply Reel Pawl 180»

The supply reel pawl 180 is structured like a leaf spring, and has a fixing end 182 and a leaf spring 184. The fixing end 182 is fixed to the pawl holder 122L of the left housing 110L. The leaf spring 184 has a long shape and can be elastically deformed while bent in a direction perpendicular to the longitudinal direction.

The tip of the leaf spring 184 has an engaging end 186. The engaging end 186 has a curved shape. The engaging end 186 is engaged with a ratchet gear 222 of a pinion 220 of the supply reel 200. The leaf spring 184 functions as a ratchet claw. The ratchet mechanism exerted by the leaf spring 184 will be described later.

### «Take-Up Reel Pawl 190»

The take-up reel pawl 190 is structured like a leaf spring, and has a fixing end 192 and a leaf spring 194. The fixing end 192 is fixed to the pawl holder 122R of the right housing 110R. The leaf spring 194 has a long shape and can be elastically deformed while bent in a direction perpendicular to the longitudinal direction.

The tip of the leaf spring 194 has an engaging end 196. The engaging end 196 has a curved shape. The engaging end 196 is engaged with a ratchet gear 322 of a pinion 320 of the take-up reel 300. The leaf spring 194 functions as a ratchet claw. The ratchet mechanism exerted by the leaf spring 194 will be described later.

### «Cap 160 and Cap Holder 170»

The cap 160 is a cover for detachably covering the cleaning head 400. The cleaning head 400 may be covered with the cap 160 to prevent contamination in the adhesive layer RL of the cleaning tape CT. Also, a cap holder 170 is formed at a rear portion of the housing 100. During cleaning with the cleaner 10, it is necessary to remove the cap 160 from the cleaning head 400. The removed cap 160 may be attached to the cap holder 170. In this case, a worker can carry out cleaning without manually holding the cap 160, so that the cleaning work can be simplified.

### «<Supply Reel 200»>

The supply reel 200 mainly has a left supply reel frame 210L and a right supply reel frame 210R. An unused cleaning tape CT is wound between the left supply reel frame 210L and the right supply reel frame 210R so that the cleaner CT can be sent out (can be supplied).

### «Left Supply Reel Frame 210L»

The left supply reel frame 210L is shaped approximately like a disk. The left supply reel frame 210L mainly has the pinion 220, a fixing part 224, and the through-hole 230.

### <Pinion 220>

The left supply reel frame 210L has the pinion 220. The pinion 220 is formed on the outside of the left supply reel frame 210L (on the side facing the left housing 110L). The pinion 220 has a substantially cylindrical shape with a low height. The pinion 220 is integrated coaxially with the left supply reel frame 210L. The ratchet gear 222 is formed along the outer peripheral surface of the pinion 220.

The ratchet gear 222 has, as components, tooth rows having asymmetric tooth surfaces. Each tooth of the ratchet gear 222 has a tooth surface with a small pressure angle (a tooth surface with a steep inclination (large inclination)) (hereinafter, referred to as a more inclined tooth surface) and a tooth surface with a large pressure angle (a tooth surface with a gentle inclination (small inclination)) (hereinafter, referred to as a less inclined tooth surface) between tooth tips. The more inclined tooth surface provides an engaging surface, and the less inclined tooth surface provides a slip surface and a sliding surface. The inclination of the tooth surface can define a rotation direction (rotation-permitted direction) in which the rotation of the supply reel 200 is permitted and a rotation direction (rotation-prohibited direction) in which the rotation is prohibited. The ratchet gear 222 and the engaging end 186 of the supply reel pawl 180 described above are components of a ratchet mechanism (return prevention mechanism).

By this ratchet mechanism, the supply reel 200 may be permitted to rotate (e.g., clockwise) in the first rotation direction (rotation-permitted direction), while the supply reel 200 may be prohibited to rotate (e.g., counterclockwise) in the second rotation direction (rotation-prohibited direction) opposite to the first rotation direction.

### <Fixing Part 224>

The fixing part 224 is formed protruding from a center region of the left supply reel frame 210L. In the supply reel 200, the fixing part 224 is oriented toward the right supply reel frame 210R. The fixing part 224 has a gap (not shown (similar to a gap 326 of a fixing part 324 of the take-up reel 300 described later)), and a first end (not shown) on the longitudinal side of the cleaning tape CT is interposed in the gap to fix the cleaning tape CT. A flat portion 228 is formed at the tip of the fixing part 224 and can hold the right supply reel frame 210R.

The through-hole 230 is formed in the center region of the left supply reel frame 210L, and the rear protrusion 118 of the right housing 110R is inserted into the through-hole 230.

### <Right Supply Reel Frame 210R>

The right supply reel frame 210R is shaped approximately like a disk. A circular through-hole 232 is formed at a center region of the right supply reel frame 210R, and the fixing part 224 of the left supply reel frame 210L is inserted into the through-hole 232.

### <Function of Supply Reel 200>

The cleaning tape CT is wound in the gap between the left supply reel frame 210L and the right supply reel frame 210R. While the supply reel 200 is rotated, an unused cleaning tape CT wound around the supply reel 200 can be gradually sent out and sent out toward the cleaning head 400. When the cleaner is wound around and held on the supply reel 200, the adhesive layer is covered by an overlapping adjacent cleaning tape CT. When unwound, the overlapping adjacent cleaning tapes CT are separated and the adhesive layer is then exposed.

### «<Take-Up Reel 300»>

The take-up reel 300 has a right take-up reel frame 310R. A used cleaning tape CT is wound around the take-up reel 300.

### «Right Take-Up Reel Frame 310R»

The right take-up reel frame 310R is shaped approximately like a disk. The right take-up reel frame 310R mainly has the pinion 320, the fixing part 324, and the through-hole 330.

### <Pinion 320>

The right take-up reel frame 310R has the pinion 320. The pinion 320 is formed on the outside of the right take-up reel frame 310R (on the side facing the right housing 110R). The pinion 320 has a substantially cylindrical shape with a low height. The pinion 320 is integrated coaxially with the right take-up reel frame 310R. The ratchet gear 322 is formed along the outer peripheral surface of the pinion 320.

The ratchet gear 322 has, as components, tooth rows having asymmetric tooth surfaces. Each tooth of the ratchet gear 322 has a tooth surface with a small pressure angle (a tooth surface with a steep inclination) and a tooth surface with a large pressure angle (a tooth surface with a gentle inclination) between tooth tips. The inclination of the tooth surface can define a rotation direction (rotation-permitted direction) in which the rotation of the take-up reel 300 is permitted and a rotation direction (rotation-prohibited direction) in which the rotation is prohibited. The ratchet gear 322 and the engaging end 196 of the take-up reel pawl 190 described above are components of a ratchet mechanism (return prevention mechanism).

By this ratchet mechanism, the take-up reel 300 may be permitted to rotate (e.g., clockwise) in the first rotation direction (rotation-permitted direction), while the take-up reel 300 may be prohibited to rotate (e.g., counterclockwise) in the second rotation direction (rotation-prohibited direction) opposite to the first rotation direction.

### «Fixing Part 324»

The fixing part 324 is formed protruding from the center region of the right take-up reel frame 310R. In the take-up reel 300, the fixing part 324 is oriented toward the left housing 110L. The fixing part 324 has the gap 326, and a second end (not shown) on the longitudinal side of the cleaning tape CT is interposed in the gap 326 to fix the cleaning tape CT. The through-hole 330 is created in the center region of the right take-up reel frame 310R, and the front protrusion 116 of the right housing 110R is inserted into the through-hole 330.

Note that although any left take-up reel frame is absent in this embodiment, a left take-up reel frame may be provided. The left take-up reel frame may be provided to accurately hold the cleaning tape CT after take-up.

### «<Head Section 40»>

In the present embodiment, the head section 40 is disposed so as to protrude from the housing 100 toward the front direction. The head section according to the present invention is not particularly limited to the form in which it is arranged so as to protrude from the housing 100 in the front direction, and may have a concave shape as long as the cleaning head is arranged so as to be able to abut on the end surface of the optical connector. The head section 40 may include the cleaning head 400 and the head holder 440.

### «Cleaning Head 400»

The cleaning head 400 includes a cleaning head distal end member 410 having a cleaning head end surface 411 that abuts against the cleaning tape CT, a cleaning head buffering member 420 that supports the cleaning head distal end member 410 that abuts against the cleaning tape CT, and a cleaning head supporting member 430 that supports these members.

At least a part of the cleaning head buffering member 420 is disposed at a position where a stress acting when the cleaning tape is brought into contact with the end surface of the optical connector is transmitted via the cleaning head distal end member 410. That is, when the cleaning tape CT is pressed against the end surface of the optical connector by being pressed against the cleaning head when the cleaner of the present invention is used, the stress generated at the end surface of the cleaning head is transmitted to the rear side via the cleaning head distal end member, is transmitted to the cleaning head buffering member 420 supporting the cleaning head distal end member 410, and is absorbed by the cleaning head buffering member 420.

The cleaning head 400 can be detachably provided on the head holder 440. It is possible to appropriately replace the corresponding cleaning head 400 according to the end surface ES of the ferrule FE for the optical connector.

The configuration of the cleaning head 400 will be described in detail below.

### <Cleaning Head Distal End Member 410>

The cleaning head distal end member 410 is disposed at the most front side of the cleaning head 400 and has a cleaning head end surface 411 for bringing the cleaning tape CT into contact with the end surface ES of the ferrule FE. The cleaning head end surface 411 has a size and a shape corresponding to the end surface ES of the ferrule FE for the optical connector.

The cleaning head distal end member 410 has a long, thin, flat rectangular parallelepiped shape. The cleaning head distal end member 410 is held at a predetermined position of a front end part 446 of the head holder 440 described later. The cleaning tape CT delivered from the supply reel is guided by the cleaning head end surface 411 and positioned on the cleaning head end surface 411.

The thickness of the cleaning head distal end member 410 in the front-rear direction is indicated as t1 in the drawing.

### (Cleaning Head End Surface 411)

The cleaning head end surface 411 is a plane.

### (Accommodation Hole (A) 412)

Two accommodation holes (A) 412 for accommodating two guide pins GP protruding from the end surface ES of the ferrule FE for the optical connector are formed in the cleaning head end surface 411. By forming the accommodation hole (A) 412, the adhesive layer RL of the cleaning tape CT can reach the root of the guide pin GP on the end surface ES of the ferrule FE for the optical connector, and dust in the vicinity of the root of the guide pin GP can be removed accurately. The removal of dust adhering to the vicinity of the root of the guide pin GP will be described in detail later (see FIGS. 16 and 17 described later).

The adhesive layer RL of the cleaning tape CT positioned at the cleaning head end surface 411 is made to face the end surface ES of the ferrule FE for the optical connector, and the adhesive layer RL is brought into contact with the end surface ES of the ferrule FE for the optical connector. Then, dust present on the end surface ES of the ferrule FE for the optical connector is transferred to the adhesive layer RL. By this transfer, dust on the end surface ES of the ferrule FE for the optical connector can be removed. After that, the cleaning tape CT is taken up from the cleaning head end surface 411 toward the take-up reel 300. The displacement of the cleaning tape CT will be described in detail later.

### <Cleaning Head Buffering Member 420>

The cleaning head according to the present invention includes a cleaning head buffering member 420.

At least a part of the cleaning head buffering member 420 is in contact with the rear side of the cleaning head distal end member 410, and is arranged so as to be capable of supporting the cleaning head distal end member 410. Further, the cleaning head buffering member 420 is disposed in contact with a cleaning head supporting member 430 disposed on the rear side. With this arrangement, when the cleaning tape CT is pressed against the cleaning head distal end member 410 and pressed against the end surface of the optical connector during use of the cleaner of the present invention, stress generated at the cleaning head end surface 411 is transmitted to the rear side via the cleaning head distal end member 410, that is, transmitted to the cleaning head buffering member 420 supporting the cleaning head distal end member 410, and absorbed by the cleaning head buffering member 420.

The shape of the cleaning head buffering member 420 is not particularly limited, and may be any shape or size capable of supporting the cleaning head distal end member 410.

The thickness of the cleaning head buffering member 420 in the front-rear direction is indicated as t2 in the drawing.

In addition, the cleaning head buffering member 420 may be formed with an accommodation hole (B) 422 at a position facing the two accommodation holes (A) 412 for housing the two guide pins GP protruding from the end surface ES of the ferrule FE for the optical connector. By forming the accommodation hole (B) 422, when the guide pin GP is longer than the thickness of the cleaning head distal end member 410, the adhesive layer RL of the cleaning tape CT can reach the root of the guide pin GP on the end surface ES of the ferrule FE for the optical connector, and the dust near the root of the guide pin GP can be removed accurately. The removal of dust adhering to the vicinity of the root of the guide pin GP will be described in detail later (see FIGS. 16 and 17, which will be described later, and the accommodation hole (B) is not shown).

### <Cleaning Head Supporting Member 430>

The cleaning head according to the present invention includes a cleaning head supporting member 430.

The cleaning head support member 430 is disposed such that at least a part thereof is brought into contact with the rear side of the cleaning head buffering member 420 and can support the cleaning head distal end member 410 and/or the cleaning head buffering member 420. The cleaning head supporting member 430 is connected to the cleaner main body via a head holder 440. With such an arrangement, when the cleaning tape CT is pressed against the end surface of the optical connector by being pressed against the cleaning head distal end member 410 during use of the cleaner of the present invention, the stress generated at the cleaning head end surface 411 is transmitted to the rear side via the cleaning head distal end member 410, that is, is transmitted to the cleaning head buffering member 420 supporting the cleaning head distal end member 410, and is further absorbed by the cleaning head supporting member 430.

The shape of the cleaning head supporting member 430 is not particularly limited, and may be any shape or size that can support the cleaning head distal end member 410 and/or the cleaning head buffering member 420 and can be connected to the head holder 440.

### «Head Holder 440»

The head holder 440 has a long and constant shape. In this embodiment, the head holder 440 has a long square tubular shape and a hollow structure. The head holder 440 houses the cleaning tape CT that can be displaced from the supply reel 200 to the take-up reel 300. Specifically, the head holder 440 houses the cleaning tape CT that is sent out from the supply reel 200, goes through the cleaning head end surface 411 of the cleaning head 410 supported by the head holder 440, and can be displaced until taken up by the take-up reel 300.

### <Holder Hole 442>

A holder hole 442 is formed on the front lateral surface of the head holder 440. A pin 432 formed on the cleaning head 410 is inserted into the holder hole 442. In this way, the cleaning head 410 can be supported at a fixed position of the head holder 440.

### <Locking Holes 444RF and 444RR and Locking Holes 444LF and 444LR>

The two locking holes 444RF and 4244RR are formed on the rear right side surface of the head holder 440. The locking hole 444RF is formed on the front side, and the locking hole 444RR is formed on the rear side. The front locking hole 444RF is engaged with the stopper 114RF of the right housing 110R, and the rear locking hole 444RR is engaged with the stopper 114RR of the right housing 110R.

In addition, the two locking holes 444LF and 444LR are formed on the rear left side surface of the head holder 440. The locking hole 444LF is formed on the front side, and the locking hole 444LR is formed on the rear side. The front locking hole 444LF is engaged with the stopper 114LF of the left housing 110L, and the rear locking hole 444LR is engaged with the stopper 114LR of the left housing 110L.

By using the locking holes 444RF and 444RR and the locking holes 444LF and 444LR, the head section 40 may be locked to the housing 100 to hold the head section 40 at a fixed position of the housing 100.

### «Location of Cleaning Head 400»

The cleaning head 400 is held and located at a certain position of the head holder 440 which has a fixed shape and is locked at a fixed position with respect to the housing 100. Thus, the cleaning head 400 is always at the fixed position with respect to the housing 100. That is, the cleaning head 400 does not move with respect to the housing 100 before, during, and after the cleaning work, and is held always at the fixed position with respect to the housing 100 and the head holder 440. The cleaning head 400 is held at the fixed position with respect to the housing 100 and the head holder 440. This allows the cleaning tape CT supplied to the cleaning head end surface 411 of the cleaning head 400 to be pressed, using a constant force, onto the end surface ES of the ferrule FE for the optical connector, thereby capable of reliably remove dust on the end surface ES regardless of a worker's skill.

The front end of the cleaning head 400 protrudes from the head holder 440, and the cleaning head end surface 411 of the cleaning head 400 is positioned protruding from the head holder 440. This allows the cleaning tape CT to be exposed to the outside, and the cleaning tape CT supplied to the cleaning head end surface 411 can be accurately brought into contact with the end surface ES of the ferrule FE for the optical connector.

Further, by projecting only the front end of the cleaning head 400 from the head holder 440, contamination in the adhesive layer RL of the cleaning tape CT is unlikely to occur. Note that the cap 160 described above may be attached to the cleaning head 400. In this case, the adhesive layer RL of the cleaning tape CT can be prevented from being contaminated when the cleaner 10 is unused, so that a clean state can be maintained.

### «Internal Structure of Head Holder 44»

Only the cleaning head 400 and the cleaning tape CT are disposed inside the head holder 440. That is, in the inside of the head holder 440, just a cleaning tape CT (supply cleaning tape CT) supplied from the supply reel 200 to the cleaning head 400, the cleaning head 400, and a cleaning tape CT (recovery cleaning tape CT) that goes through the cleaning head 400 and is taken up by the take-up reel 300 are present. In addition, the adhesive layer RL of the cleaning tape CT sent out from the supply reel 200 is in an exposed state. Due to this, the supply cleaning tape CT and the recovery cleaning tape CT are substantially linearly moved (on a flat plane) inside the head holder 440. This can prevent the adhesive layer RL of the cleaning tape CT from coming into contact with the inner wall of the head holder 440 and protect the adhesive layer RL from contamination.

Furthermore, the coil spring 140 for driving the controller main body 510 is located at a rear portion of the housing 100, that is, located at a position away from the head holder 440. Even if dust occurs due to expansion and contraction of the coil spring 140, the adhesive layer RL can be prevented from contamination.

Moreover, the coil spring 140 arranged at the rear portion of the housing 100 is housed inside the spring holders 124L and 124R.The spring holders 124L and 124R can function as partition walls. This can prevent dust from spreading due to the expansion and contraction of the coil spring 140.

### «<Take-Up Controller 500»>

The take-up controller 500 has the controller main body 510, a control end surface 520, a take-up extending portion 530, and the coil spring pressing portion 540.

### «Controller Main Body 510»

The controller main body 510 has a long substantially square tubular shape and has a through-hole in the longitudinal direction. That is, the controller main body 510 has a hollow structure, and the above-mentioned head section 40 (head holder 440 and cleaning head 400) is housed inside the controller main body 510. The controller main body 510 can move along the longitudinal direction of the head section 40 with respect to the head section 40 housed inside. The controller main body 510 can move outside the head section 40 along the longitudinal direction of the head section 40, and the movement of the controller main body 510 can cause the entire take-up controller 500 to move along the longitudinal direction of the head section 40 with respect to the head section 40 and the housing 100. The movement and operation of the take-up controller 500 will be described later.

### <Guide Ridge 512R and Guide Ridge 512L>

Two guide ridges 512R are formed on the right side surface of the controller main body 510. The two guiding ridges 512R are each shaped like a long ridge. The two guide ridges 512R are formed at two locations, an upper site and a lower site of the right side surface of the controller main body 510, and are in parallel to each other along the longitudinal direction of the controller main body 510.

Two guide ridges 512L are formed on the left side surface of the controller main body 510. The two guide ridges 512L are each shaped like a long ridge. The two guide ridges 512L are formed at two locations, an upper site and a lower site of the left side surface of the controller main body 510, and are in parallel to each other along the longitudinal direction of the controller main body 510.

### <Movement Control Hole 514R and Movement Control Hole 514L>

A long movement control hole 514R is formed on the right side surface of the controller main body 510. The movement control hole 514R is shaped like a substantially long oval through-hole. The movement control hole 514R is formed between the two long guide ridges 512R along the longitudinal direction of the controller main body 510.

A long movement control hole 514L is formed on the left side surface of the controller main body 510. The movement control hole 514L is shaped like a substantially long oval through-hole. The movement control hole 514L is formed between the two long guide ridges 512L along the longitudinal direction of the controller main body 510.

The movement control hole 514R and the movement control hole 514L are formed so as to face each other on the right side surface and the left side surface of the controller main body 510.

### «Control End Surface 520»

The control end surface 520 is an end surface formed at a front end portion of the controller main body 510. The control end surface 520 faces and comes into contact with the housing end surface OS of the optical connector OC, and is formed so as to be able to be engaged with the housing end surface OS. Specifically, the cleaner 10 may be gripped by a worker during the work of cleaning the end surface ES of the ferrule FE and the cleaner 10 may be brought close to the optical connector OC. In this case, first, the cleaner 10 is positioned such that the control end surface 520 faces the housing end surface OS of the optical connector OC. Next, the control end surface 520 is brought close to the housing end surface OS of the optical connector OC until they are in contact (engaged).

Further, the worker may apply force to the cleaner 10 while maintaining the state in which the control end surface 520 of the controller main body 510 is in contact (engagement) with the housing end surface OS of the optical connector OC. In this case, the controller main body 510 is pressed by the housing end surface OS to be displaced rearward relative to the housing 100. Also, the cleaning head end surface 411 of the cleaning head 400 is brought closer to the end surface ES of the ferrule FE for the optical connector OC. When the controller main body 510 is displaced rearward relative to the housing 100, a cleaning tape CT is newly sent out from the supply reel 200, and the cleaning tape CT to be supplied to the cleaning head end surface 411 of the cleaning head 400 should move.

When the worker further applies force to the cleaner 10, the controller main body 510 further moves rearward relative to the housing 100, and the cleaning head end surface 411 of the cleaning head 400 is brought closer to and comes into contact with the end surface ES of the ferrule FE for the optical connector OC. When the controller main body 510 further moves to the rear side of the housing 100, a cleaning tape CT is newly sent out from the supply reel 200, and the clean adhesive layer RL of the cleaning tape CT is supplied to the cleaning head end surface 411 of the cleaning head 410. Thus, when the cleaning head end surface 411 of the cleaning head 400 comes into contact with the end surface ES of the ferrule FE for the optical connector OC, the clean adhesive layer RL of the cleaning tape CT comes into contact with the end surface ES of the ferrule FE.

In this way, the worker applies force to the cleaner 10 and pushes the cleaner 10 onto the optical connector OC. As a result, a cleaning tape CT is sent out from the supply reel 200 while the cleaning head end surface 411 of the cleaning head 400 is brought closer to the end surface ES of the ferrule FE for the optical connector OC. This makes it possible to always bring the clean adhesive layer RL of the cleaning tape CT into contact with the end surface ES of the ferrule FE. Note that the specific movements of the cleaning head 400, the controller main body 510, and the cleaning tape CT will be described later with reference to FIGS. 13A to 17D.

Note that when the worker applies force to the cleaner 10, the controller main body 510 moves relative to the housing 100 and the head section 40. This causes a state in which the cleaning head end surface 411 of the cleaning head 400 is engaged with the end surface ES of the ferrule FE for the optical connector OC. As a result, the take-up controller 500 and the controller main body 510 rest with respect to the optical connector OC. In reality, the housing 100 and the head section 40 are moved toward the optical connector OC.

### «Take-Up Extending Portion 530»

The take-up extending portion 530 is provided extending from the controller main body 510 toward the take-up reel 300. The take-up extending portion 530 has a curved part 532 and a rack formation part 534.

### <Curved Part 532> (Urging Force Generating Part)

The curved part 532 has a shape curved approximately 90 degrees. The curved part 532 projects substantially perpendicular to the longitudinal direction of the head section 40, is curved approximately 90 degrees, is substantially parallel to the longitudinal direction of the head section 40, and extends toward the take-up reel 300. The curved part 532 is made of material that can be elastically deformed, and can be elastically deformed accordingly.

<Rack formation Part 534>

The rack formation part 534 is connected to the curved part 532 and has a substantially linear elongated shape. In the rack formation part 534, a rack (a row of teeth where the tooth tips are arranged on a plane) 536 is formed along the longitudinal direction of the head section 40. The rack 536 is engaged with the ratchet gear 322 of the take-up reel 300.

When the controller main body 510 is moved in the front-rear direction, the rack formation part 534 can also move in the front-rear direction. The take-up reel 300 can be rotated while the rack formation part 534 moves in the front-rear direction. The movements of the controller main body 510 and the take-up reel 300 will be described in detail later.

### <Coil Spring Pressing Portion 540>

The coil spring pressing portion 540 is formed at the rear end of the take-up controller 500. The moving end 144 of the coil spring 140 is engaged with the coil spring pressing portion 540. Side portions of the coil spring 140 are supported by the spring holder 124L and the spring holder 124R, and the coil spring 140 is stretchably held between the coil spring pressing portion 540 and the spring stopper 126 of the left housing 110L.

««Movement of Cleaner 10 (How to Operate Cleaner 10)»»The following describes movement of the cleaner 10. As described above, a worker may push the cleaner 10 onto the optical connector OC to move the take-up controller 500 with respect to the housing 100 and the head section 40. Hereinafter, first, the movement of only the take-up controller 500 will be described, and then the movements of the take-up controller 500 and the take-up reel 300 will be described.

### «<Movement of Take-Up Controller 500 (How to Operate Controller Main Body 510)»>

As described above, the controller main body 510 has a hollow structure, and the controller main body 510 houses, in its inside, the head section 40 (head holder 440 and cleaning head 400) described above. The controller main body 510 can slide outside the head section 40 with respect to the head section 40 housed inside. Specifically, when the worker pushes the cleaner 10 onto the optical connector OC, the controller main body 510 is engaged with the housing end surface OS of the optical connector OC, and the controller main body 510 is displaced in the longitudinal direction of the head section 40 (that is, in the front-rear direction of the cleaning tape CT).

### <Maximum Front Position MF of Take-Up Controller 500>

FIG. 13A shows the state when the controller main body 510 is located at the frontmost position. When the movement control hole 514R is engaged with the stopper 114RF and the movement control hole 514L is engaged with the stopper 114LF, the controller main body 510 is locked by the stopper 114RF and the stopper 114LF. Accordingly, the controller main body 510 is located at the frontmost position (maximum front position MF). When no force is applied to the controller main body 510 by the worker, the urging force of the coil spring 140 causes the controller main body 510 to move forward and be positioned at the maximum front position MF. This maximum front position MF is the home position of the controller main body 510.

### <Intermediate Position of Take-Up Controller 500>

FIG. 13B shows a state in which the controller main body 510 has moved slightly rearward from the maximum front position MF. As described above, when the worker applies force to the cleaner 10 while maintaining the state in which the control end surface 520 of the controller main body 510 is in contact (engagement) with the housing end surface OS of the optical connector OC, the controller main body 510 is pressed by the housing end surface OS and moves from the maximum front position MF to the rear side of the housing 100. When the controller main body 510 has moved to the rear side, part of the controller main body 510 is housed inside the housing 100, part of the head holder 440 is exposed from the controller main body 510, and the cleaning head end surface 411 of the cleaning head 400 is brought closer to the end surface ES of the ferrule FE for the optical connector OC.

<Contact with Ferrule FE>

When the controller main body 510 is further moved to the rear side by further increasing the force with which the worker pushes the cleaner 10 onto the optical connector OC, part of the head holder 440 is further exposed from the controller main body 510. Then, the cleaning head end surface 411 is brought into contact with the end surface ES of the ferrule FE for the optical connector OC.

### <Maximum Rear Position MR of Take-Up Controller 500>

In FIG. 14, when the movement control hole 514R is engaged with the stopper 114RR and the movement control hole 514L is engaged with the stopper 114LR, the controller main body 510 is locked by the stopper 114RR and the stopper 114LR. Accordingly, the controller main body 510 is located at the rearmost position (maximum rear position MR). In this way, the controller main body 510 can be stopped at the maximum rear position MR. The controller main body 510 may be stopped at the maximum rear position MR, and the worker may try to strengthen the force to push the cleaner 10 onto the optical connector OC and then to strongly press the ferrule FE for the optical connector OC. Even in this case, it is possible to prevent the ferrule FE from being damaged.

As described above, the coil spring 140 is provided at the rear portion of the controller main body 510, and the coil spring 140 applies an urging force to the controller main body 510. When the worker weakens the force applied to the controller main body 510, the controller main body 510 can move to the maximum front position MF and return to the home position by the urging force of the coil spring 140. In this way, the take-up controller 500 can move between the maximum front position MF and the maximum rear position MR.

### «Movements of Take-Up Controller 500 and Take-Up Reel 300»

As described above, the movement of the controller main body 510 can cause the take-up controller 500 to be displaced to the rear side or the front side of the cleaner 10. Here, the movement of the take-up controller 500 and the movement of the take-up reel 300 will be described.

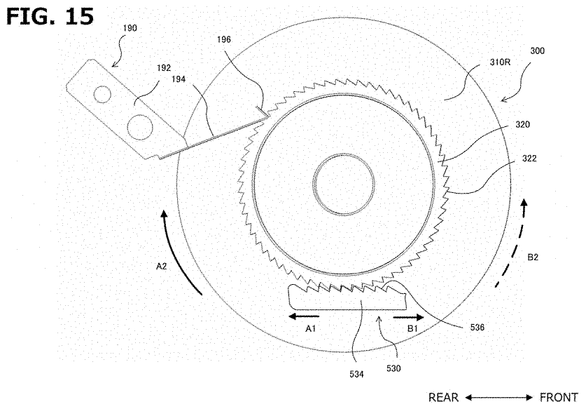

As described above, the controller main body 510 has the take-up extending portion 530, and the rack 536 is formed at the take-up extending portion 530. The rack 536 engages with the ratchet gear 322 of the take-up reel 300. In addition, the take-up reel pawl 190 has the leaf spring 194, and the leaf spring 194 has the engaging end 196. This engaging end 196 also engages with the ratchet gear 322 of the take-up reel 300. That is, two members, the rack 536 of the controller main body 510 and the engaging end 196 of the take-up reel pawl 190, are engaged with the ratchet gear 322 of the take-up reel 300. Then, the movement of the take-up reel 300 can be controlled by the state of engagement with each other. FIG. 15 is a schematic view showing a state of engagement between the rack 536 and the ratchet gear 322 and engagement between the engaging end 196 and the ratchet gear 322. Note that the rack 536 is covered by the take-up extending portion 530 (see, for instance, FIGS. 13A to 14), but the rack 536 is depicted in FIG. 15 for explanation.

### «When Force Is Applied to Controller Main Body 510»

<Engagement between Ratchet Gear 322 and Rack 536>

When a rearward force (see arrow A1 in FIG. 13B and FIG. 15) is applied to the controller main body 510, a more inclined tooth surface of the ratchet gear 322 of the take-up reel 300 and a more inclined tooth surface of the rack 536 of the take-up extending portion 530 face each other and are engaged. This engagement transmits, from the rack 536 of the take-up extending portion 530 to the ratchet gear 322 of the take-up reel 300, a force that can cause rotation of the take-up reel 300. In the drawings of FIGS. 13B and 15, the force that allows the take-up reel 300 to rotate clockwise (see arrow A2) is transmitted. The rack-and-pinion mechanism is structured by the rack 536 of the take-up extending portion 530 and the ratchet gear 322 of the take-up reel 300, and converts the linear motion into a rotary motion to transmit the movement.

<Disengagement between Ratchet Gear 322 and Engaging End 196>

When a force (force that can cause clockwise rotation in the drawings of FIG. 13B and FIG. 15 (see arrow A2)) is transmitted to the ratchet gear 322 of the take-up reel 300, the take-up reel 300 is moved in such a direction that a more inclined tooth surface of the ratchet gear 322 of the take-up reel 300 and a more inclined tooth surface of the engaging end 196 of the leaf spring 194 are apart from each other. This causes disengagement between the more inclined tooth surface of the ratchet gear 322 of the take-up reel 300 and the more inclined tooth surface of the engaging end 196 of the leaf spring 194. Thus, the rotational movement of the take-up reel 300 is not prohibited. In this way, when the worker applies force to the controller main body 510 to displace the take-up controller 500 rearward (see arrow A1 in FIGS. 13B and 15), the take-up reel 300 can be rotated clockwise (see arrow A2 in FIGS. 13B and FIG. 15).

Note that when the take-up reel 300 rotates (rotates clockwise in the drawings of FIGS. 13B and 15), a small inclined small tooth surface of the engaging end 196 of the leaf spring 194 and a less inclined tooth surface of ratchet gear 322 of the take-up reel 300 come into contact with each other. Further, as the take-up reel 300 rotates, the leaf spring 194 is pressed by a tooth of the ratchet gear 322 while sliding in contact with the tooth of the ratchet gear 322, and is subject to gradual elastic deformation. When the engaging end 196 of the leaf spring 194 passes through a tooth tip of the ratchet gear 322, the leaf spring 194 is released from elastic deformation and returns to its original shape.

<How to Pull and Supply Cleaning tape CT>

In this way, when a force is applied to the controller main body 510 and the take-up controller 500 moves rearward, the force is transmitted to the take-up reel 300 by the movement of the controller main body 510, thereby causing the take-up reel 300 to rotate. As the take-up reel 300 rotates, the cleaning tape CT is pulled (see arrow A3 in FIG. 13B) and is wound around the take-up reel 300. When the cleaning tape CT is pulled, a cleaning tape CT is newly sent out from the supply reel 200 (see arrow A4 in FIG. 13B), and the clean adhesive layer RL of the cleaning tape CT is supplied to the cleaning head end surface 411 of the cleaning head distal end member 410 (see arrow A5 in FIG. 13B). When a force is applied to the controller main body 510 and the take-up controller 500 moves rearward, the take-up controller 500 can be moved to the maximum rear position MR (the state in FIG. 14).

### «When Force Applied to Controller Main Body 510 Weakens»

<Engagement between Ratchet Gear 322 and Rack 536>

Next, when the force applied to the controller main body 510 weakens after the take-up controller 500 is displaced rearward, the take-up controller 500 attempts to move forward due to the urging force of the coil spring 140 as described above (see arrow B1 in FIGS. 15 and 13B). That is, the take-up controller 500 attempts to move in a direction in which a more inclined tooth surface of the ratchet gear 322 of the take-up reel 300 and a more inclined tooth surface of the rack 536 of the take-up extending portion 530 are apart from each other. Accordingly, the more inclined tooth surface of the ratchet gear 322 of the take-up reel 300 and the more inclined tooth surface of the rack 536 of the take-up extending portion 530 disengages. Thus, the forward movement of take-up controller 500 is not prohibited.

Note that when the take-up controller 500 is moved forward, a less inclined tooth surface of the rack 536 of the take-up extending portion 530 comes into contact with a less inclined tooth surface of the ratchet gear 322 of the take-up reel 300. Further, as the take-up controller 500 moves, the take-up extending portion 530 is pressed by a tooth of the ratchet gear 322 while sliding in contact with the tooth of the ratchet gear 322, and is subject to gradual elastic deformation. When the rack 536 of the take-up extending portion 530 passes through a tooth tip of the ratchet gear 322, the elastic deformation is released and the rack 536 returns to its original shape.

<Engagement between Ratchet Gear 322 and Engaging End 196>

Further, when the take-up controller 500 is moved forward, a less inclined tooth surface of the rack 536 of the take-up extending portion 530 comes into contact with a less inclined tooth surface of the ratchet gear 322 of the take-up reel 300. This applies force that allows the take-up reel 300 to rotate. In the drawing of FIG. 15, the force that allows the take-up reel 300 to rotate counterclockwise is transmitted (see the dashed arrow B2 of FIG. 15). When the force causing the counterclockwise rotation is transmitted to the ratchet gear 322 of the take-up reel 300, a more inclined tooth surface of the ratchet gear 322 of the take-up reel 300 and a more inclined tooth surface of the engaging end 196 of the leaf spring 194 face each other and are engaged. This engagement may transmit a force that allows the take-up reel 300 to rotate counterclockwise. Even in this case, the rotational movement of the take-up reel 300 is not prohibited; or the take-up reel 300 does not rotate counterclockwise. The engagement between the ratchet gear 322 and the engaging end 196 provides a return prevention mechanism.

<Engagement between Ratchet Gear 222 and Engaging End 186>

As described above, the supply reel pawl 180 has the leaf spring 184, and the leaf spring 184 has the engaging end 186 (see FIG. 6). In addition, the supply reel 200 is provided with the ratchet gear 222. The engaging end 186 of the leaf spring 184 engages with the ratchet gear 222 of the supply reel 200. When a force in a direction in which the cleaning tape CT returns to the supply reel 200 is applied via the cleaning tape CT, a more inclined tooth surface of the ratchet gear 222 of the supply reel 200 and a more inclined tooth surface of the engaging end 186 of the leaf spring 184 face each other and are engaged. This engagement can prohibit the rotational movement of the supply reel 200 even when the force in a direction in which the cleaning tape CT returns to the supply reel 200 is transmitted. The engagement between the ratchet gear 222 and the engaging end 186 provides a return prevention mechanism.

In this way, when the force applied to the controller main body 510 weakens, the take-up reel 300 does not rotate, and the take-up controller 500 is moved forward by the urging force of the coil spring 140 (see arrow B1 in FIGS. 15 and 13B). Accordingly, the take-up controller 500 can return to the home position while the cleaning tape CT wound around the take-up reel 300 is not released and can be maintained in the wound state (in the state in FIG. 13A). When the take-up controller 500 returns to the home position, the rotational movement of the take-up reel 300 is prohibited. This makes it possible to prevent the dust-contaminated cleaning tape CT from returning to the cleaning head 400.

<Feed Length FL of Cleaning tape CT>

The take-up controller 500 is positioned at the maximum front position MF by the stopper 114RF and the stopper 114LF, and is positioned at the maximum rear position MR by the stopper 114RR and the stopper 114LR. Thus, the take-up controller 500 can always be displaced at a fixed distance (see FL in FIGS. 13A and 14). Also, the feed length of the cleaning tape CT can be constant. This enables a clean adhesive layer RL to be constantly supplied to the cleaning head end surface 411 of the cleaning head 400 regardless of a worker's ability and skill level.

### «<Cleaner CT Path»>

The cleaning tape CT is wound around the supply reel 200, and the adhesive layer RL of the cleaning tape CT is covered by an adjacent cleaning tape CT. Due to this, the adhesive layer RL of the cleaning tape CT is not contaminated.

The supply reel 200 is held in the housing 100, and the cleaning tape CT sent out from the supply reel 200 is housed in the housing 100 and the head holder 440 until it reaches the cleaning head 400. As a result, the adhesive layer RL of the cleaning tape CT can be kept clean.

When the cleaning tape CT is sent out from the supply reel 200, the cleaning tape CT is unwound and the adhesive layer RL of the cleaning tape CT is exposed. After the cleaning tape CT is sent out from the supply reel 200, the adhesive layer RL of the cleaning tape CT preferably goes straight and reaches the cleaning head 400 without contact with any other member. A face opposite to the adhesive layer RL contacts on, for instance, a roller or a guide, and the path of the cleaning tape CT can be changed by them. In addition, even if the adhesive layer RL of the cleaning tape CT comes into contact with a member, the adhesive layer RL of the cleaning tape CT can be kept clean by using the clean member.

### ««Procedure for Cleaning Work»»

First, a worker brings the control end surface 520 close to the housing end surface OS of the optical connector OC until they are in contact (engaged). Next, when the worker applies force to the cleaner 10 while maintaining the state in which the control end surface 520 of the controller main body 510 is in contact (engagement) with the housing end surface OS of the optical connector OC, the controller main body 510 is pressed by the housing end surface OS and moves rearward relative to the housing 100. This brings the cleaning head end surface 411 of the cleaning head 400 close to the end surface ES of the ferrule FE for the optical connector OC.

As the controller main body 510 moves rearward relative to the housing 100 (arrow A1 in FIG. 13B), the take-up reel 300 rotates in the take-up direction at a rotation angle corresponding to the movement of the controller main body 510 (arrow A2 in FIG. 13B). The cleaning tape CT is pulled by the rotation of the take-up reel 300 (arrow A3 in FIG. 13B), and is wound around the take-up reel 300.

When the cleaning tape CT is pulled by the take-up reel 300 (arrow A3 in FIG. 13B), a cleaning tape CT is sent out from the supply reel 200 (arrow A4 in FIG. 13B), and a clean adhesive layer RL of the cleaning tape CT is supplied to the cleaning head end surface 411 of the cleaning head 400 (arrow A5 in FIG. 13B).

After that, the worker strengthens the force applied to the cleaner 10 to bring the cleaning head end surface 411 of the cleaning head 400 closer to the end surface ES of the ferrule FE for the optical connector. By pressing the adhesive layer RL of the cleaning tape CT against the end surface ES of the ferrule FE for the optical connector, dust on the end surface ES of the ferrule FE for the optical connector is transferred to the adhesive layer RL. This makes it possible to clean the end surface ES of the ferrule FE for the optical connector.

With this configuration, the cleaning tape CT can be pulled continuously as the controller main body 510 moves relatively. That is, the controller main body 510 continues to move and the cleaning tape CT is pulled until the cleaning head end surface 411 of the cleaning head 400 reaches the end surface ES of the ferrule FE for the optical connector OC. Accordingly, by the time until the adhesive layer RL of the cleaning tape CT is pressed onto the end surface ES of the ferrule FE for the optical connector, the cleaning tape CT located at the cleaning head end surface 411 of the cleaning head 400 is displaced to a position away from the cleaning head end surface 411. In this way, a clean adhesive layer RL of the cleaning tape CT is newly supplied and positioned at the cleaning head end surface 411. That is, before the adhesive layer RL of the cleaning tape CT comes into contact with the end surface ES of the ferrule FE for the optical connector, the clean adhesive layer RL of another cleaning tape CT can be newly supplied to the cleaning head end surface 411.

After the cleaning is completed, the worker weakens the force applied to the cleaner 10. Next, the urging force of the coil spring 140 causes the controller main body 510 to move relatively forward and then returns to the home position.

Note that when the controller main body 510 is moved forward, the ratchet gear 322 is locked by the engaging end 196. Thus, the rotational movement of the take-up reel 300 is prohibited. This can keep, at the position of the cleaning head end surface 411, the adhesive layer RL of the cleaning tape CT having been supplied to the cleaning head end surface 411 of the cleaning head 400 while the cleaning tape CT rests.

### «Tape Supply Mechanism»

The tape supply mechanism according to the present invention may be a known tape supply mechanism, and is not particularly limited. In the present embodiment, the cleaning tape CT (supply cleaning tape CT) is supplied from the supply reel 200 to the cleaning head 400 by the rack 536, the ratchet gear 322, and the like, and is further wound around the winding reel 300 via the cleaning head 400 and the cleaning head 400.

««Process of Cleaning with Cleaner 10 »»

FIGS. 16A to 16D are cross-sectional views showing a process of cleaning the end surface ES of the ferrule FE for the optical connector by using the cleaner 10. For instance, MPO connectors may be used for the cleaning. FIGS. 16A to 16D show the relative positional relationship between the ferrule FE and the cleaning tape CT during the cleaning process. In the example shown in FIGS. 16A to 16D, the ferrule FE is provided with ends of 12 optical fibers OF arranged side by side. In addition, the ferrule FE has two guide pins GP provided so as to protrude vertically (in a direction away from the end surface ES) relative to the end surface ES of the ferrule FE with the 12 optical fibers OF interposed therebetween.

First, as shown in FIG. 2, a worker grips the cleaner 10 and brings the cleaning head 400 of the cleaner 10 close to the opening OP of the optical connector OC so as to face each other. Next, the housing end surface OS of the optical connector OC is engaged with the control end surface 520 of the controller main body 510, and a force is then applied to the cleaner 10. By applying the force, the cleaning head 400 can be inserted into the opening OP of the optical connector OC while the controller main body 510 is housed in the housing 100. This can bring the cleaning head end surface 411 of the head section 40 close to the end surface ES of the ferrule FE for the optical connector OC. Further, by strengthening the force applied to the cleaner 10, the adhesive layer RL of the cleaning tape CT can be tightly attached to the end surface ES of the ferrule FE. The specific process will be described below.

First, as shown in FIG. 16A, when the worker inserts the cleaning head 400 into the opening OP of the optical connector OC, the adhesive layer RL of the cleaning tape CT faces the end surface ES of the ferrule FE at a distal position.

Further, as shown in FIG. 16B, when the worker applies a force to the cleaner 10 toward the optical connector OC, the control end surface 520 of the controller main body 510 engages with the housing end surface OS of the optical connector OC. This can bring the adhesive layer RL of the cleaning tape CT at the cleaning head end surface 411 of the head section 40 close to the end surface ES of the ferrule FE for the optical connector OC. In the state shown in FIG. 16B, the adhesive layer RL of the cleaning tape CT comes into contact with the tips of the two guide pins GP of the ferrule FE and is pressed by the two guide pins GP to elastically deform.

Next, as shown in FIG. 16C, when the worker further applies force, the adhesive layer RL of the cleaning tape CT is brought closer to the end surface ES of the ferrule FE for the optical connector OC. At this time, the adhesive layer RL is pressed by the two guide pins GP and an urging force (restoring force) generated in the adhesive layer RL is used to start covering the two guide pins GP.

Then, as shown in FIG. 16D, when the worker further applies force to the cleaner 10, the adhesive layer RL reaches the end surface ES of the ferrule FE. At this time, the areas of the adhesive layer RL elastically deformed by the contact with the two guide pins GP cover the roots of the two guide pins GP due to the urging force (restoring force) generated in the adhesive layer RL. The roots of the two guide pins GP are covered by the adhesive layer RL, so that the adhesive layer RL can be tightly attached to the entire end surface ES of the ferrule FE without creating a gap between the adhesive layer RL and the end surface ES of the ferrule FE. By attaching the adhesive layer RL to the roots of the two guide pins GP, dust on the entire end surface ES of the ferrule FE can be transferred using the adhesive force of the adhesive layer RL. The dust is attached to the end surface ES of the ferrule FE due to electrostatic force and so on. Dust around the roots of the two guide pins GP and dust attached to the two guide pins GP can also be transferred and removed by the adhesive force of the adhesive layer RL. The elastic modulus and hardness of the adhesive layer RL may be suitably selected. In this case, the urging force (restoring force) of the adhesive layer RL can be used to cover the entire two guide pins GP by the adhesive layer RL.

The cleaning head 400 has the accommodation holes (A) 412 for accommodating the two guide pins GP. When the adhesive layer RL reaches the end surface ES of the ferrule FE, the adhesive layer RL, together with the entire guide pin GP, is accommodated in each accommodation hole (A) 412. By providing each accommodation hole (A) 412, dust can be accurately removed even in the case of ferrule FE having a guide pin GP. In addition, the adhesive layer RL can also be accommodated in the accommodation hole (A) 412. Due to this, deformation of the adhesive layer RL due to the urging force (restoring force) is not prevented. As a result, the entire guide pin GP can be covered with the adhesive layer RL.

FIGS. 16A to 16D described above illustrate an example in which the adhesive layer RL is elastically deformed according to the shape and size of the two guide pins GP without being punctured by the two guide pins GP; and the adhesive layer RL covers even the roots of the two guide pins GP by using the urging force (restoring force) generated in the adhesive layer RL. However, the adhesive layer RL may be punctured by the two guide pins GP to plastically deform the adhesive layer RL. FIGS. 17A to 17D are diagrams showing an example of the case where the adhesive layer RL is subject to plastic deformation. Whether the adhesive layer RL is elastically deformed or plastically deformed may be determined, if appropriate, depending on the Shore A hardness of the adhesive layer RL.

FIG. 17A is in the same state as in FIG. 16A. As shown in FIG. 17B, when the two guide pins GP come into contact with the cleaning tape CT (adhesive layer RL) and are pressed, the adhesive layer RL is punctured by the two guide pins GP and is plastically deformed. The puncture starts from the beginning of contact with the two guide pins GP. Next, as shown in FIG. 17C, when the cleaning tape CT is pushed, plastic deformation progresses further, and the two guide pins GP are gradually stabbed into the adhesive layer RL. Finally, as shown in FIG. 17D, the cleaning tape CT reaches the end surface ES of the ferrule FE while the adhesive layer RL is plastically deformed.

In this way, even when the adhesive layer RL is plastically deformed, the adhesive layer RL of the cleaning tape CT can be attached to the roots of the two guide pins GP. Even in this case, dust around the roots of the two guide pins GP and dust attached to the two guide pins GP can also be transferred and removed by the adhesive force of the adhesive layer RL.

### EXAMPLES

<Material used for Cleaning Head>

The materials used for the cleaning heads of Examples and Comparative

Examples are shown in Table 1.

### (Storage Elastic Modulus Measuring Method)

The storage modulus at 40° C. of each material in Table 1 was determined by the following method. The frequency was taken as 1 Hz and measured in accordance with JIS K7244-4. Detailed measurement conditions are as follows.
Device name: DYNAMIC MECHANICAL ANALYSIS
Manufacturer.
Model: DMS61000
(measurement condition)

Temperature: 50 to 120° C.
Heating rate: 3° C./min/min
Load: 50 mN
Frequency: 1 Hz
Tension mode: Tension mode

(Sample size)
Length: 10 mm, width: 7 mm

TABLE 1

| | Material | | | | | | | | | | | |
|---|---|---|---|---|---|---|---|---|---|---|---|---|
| | Buffering | Distal end | Supporting | | | | | | | | | |
| | member | member | member | Storage | | | | | | | | |
| | Dimension: | Dimension: | Dimension: | elastic | | | | | | | | |
| | 6.4 mm × | 6.4 mm × | 6.4 mm × | modulus | | | | | | Full | Tape | Total |
| | 4.5 mm × | 0.8 mm × | 2.1 mm × | (MPa) | | | E2/ | E3/ | E1/ | adhe- | convey- | evalu- |
| | 2.3 mm | 2.3 mm | 2.3 mm | E1 | E2 | E3 | E1 | E1 | E4 | sion | ance | ation |
| Example1 | Tefabloc | Toyolac | Toyolac | 0.4 | 410 | 410 | 1025 | 1025 | 4.0 | ⊚ | ⊚ | ⊚ |
| | SJ-6400 | 920-555(ABS) | 920-555(ABS) | | | | | | | | | |
| Example2 | Haplagel | Toyolac | Toyolac | 0.1 | 410 | 410 | 4100 | 4100 | 1.0 | ⊚ | ⊚ | ⊚ |
| | #1360 | 920-555(ABS) | 920-555(ABS) | | | | | | | | | |
| Example3 | Silicone | Toyolac | Toyolac | 0.7 | 410 | 410 | 586 | 586 | 7.1 | ⊚ | ⊚ | ⊚ |
| | rubber | 920-555(ABS) | 920-555(ABS) | | | | | | | | | |
| Example4 | Haplagel | Toyolac | Toyolac | 0.08 | 410 | 410 | 5125 | 5125 | 0.8 | ◯ | ⊚ | ◯ |
| | #1315 | 920-555(ABS) | 920-555(ABS) | | | | | | | | | |
| Example5 | Premalloy | Toyolac | Toyolac | 0.8 | 410 | 410 | 513 | 513 | 8.1 | ◯ | ⊚ | ◯ |
| | 1602N | 920-555(ABS) | 920-555(ABS) | | | | | | | | | |
| Example6 | Tefabloc | Clarex001(Acrylic) | Toyolac | 0.4 | 260 | 410 | 650 | 1025 | 4.0 | ⊚ | ◯ | ◯ |
| | SJ-6400 | | 920-555(ABS) | | | | | | | | | |
| Example7 | Tefabloc | Toyolac | Clarex001(Acrylic) | 0.4 | 410 | 260 | 1025 | 650 | 4.0 | ⊚ | ◯ | ◯ |
| | SJ-6400 | 920-555(ABS) | | | | | | | | | | |
| Compar- | Tefabloc | Tefabloc | Tefabloc | 0.4 | 0.4 | 0 4 | 1 | 1 | 4.0 | X | X | X |
| ative | SJ-6400 | SJ-6400 | SJ-6400 | | | | | | | | | |
| Example 1 | | | | | | | | | | | | |
| Compar- | Toyolac | Toyolac | Toyolac | 410 | 410 | 410 | 1 | 1 | 4141 | X | ⊚ | X |
| ative | 920-555(ABS) | 920-555(ABS) | 920-555(ABS) | | | | | | | | | |
| Example 2 | | | | | | | | | | | | |
| Compar- | Toyolac | Tefabloc | Tefabloc | 410 | 0.4 | 0 4 | 0 001 | 0.0010 | 4141 | X | X | X |
| ative | 920-555(ABS) | SJ-6400 | SJ-6400 | | | | | | | | | |
| Example 3 | | | | | | | | | | | | |

The cleaning heads of Examples and Comparative Examples were processed and assembled so that t1 was 1 mm and t2 was 4.65 mm, respectively, to have the configuration shown in Table 1. Thereafter, the cleaner body of the above-described embodiment was connected.

A cleaning tape prepared by the following method was used for each cleaner to which the cleaning head of each of Examples and Comparative Examples was connected to prepare a cleaner for evaluation.

### (Preparation of Adhesive Layer)

A mixture of 10% by mass of an ester-based diol having a number average molecular weight of 1500, 80% by mass of an ether-based diol having a number average molecular weight of 2000, and 10% by mass of an ether-based triol having a number average molecular weight of 1500 was prepared as a main agent. A mixture of a monomeric diphenylmethane diisocyanate carbodiimide-modified isocyanate, an ether-based triol having a number average molecular weight of 3000, and an ester-based diol having a number average molecular weight of 500 was reacted at 80° C. for 2 hours to prepare a prepolymer having an NCO of about 18.9% as a curing agent. The curing agent was transferred to a container, and the main agent was weighed so that the hydroxyl group of the polyol of the main agent and the isocyanate group of the polyisocyanate of the curing agent were in an equivalent ratio of 1.1 (equivalent amount of isocyanate group/equivalent amount of hydroxyl group), and dropped onto the curing agent while stirring. After completion of the addition of the catalyst (dibutyltin dilaurate 0.3 g), the mixture was thoroughly mixed and then degassed under vacuum to obtain a mixed liquid.

(Preparation of cleaning tape)

Next, the mixed liquid obtained by the above-described method was flowed onto a PET film having a thickness of 25 μm (Unitika; S-25), and was formed into a film shape having a film thickness of 350 μm by using an applicator (Film applicator No. 350FA; Coating Tester Industry), and a urethane reaction was performed in a drying furnace at 100° C. for 60 minutes to complete the curing. A cleaning tape having a thickness of 350 μm was obtained. The PET film was used as a base material of the cleaning tape as it is. The E4 of the adhesive layer of the obtained cleaning tape was 0.099 MPa.

### <Evaluation>

The cleaner of each of Examples and Comparative Examples was evaluated by the following method.

### (Adhesive Contact of Entire Tape)

The adhesiveness of the entire surface of the tape of each of Examples and Comparative Examples was evaluated by the following method. For the evaluation, MPO jumper cord manufactured by Senko Advance Co., Ltd., 12MPO at both ends, OM3 cord type, full length 1 m, flat polishing or APC8 degree polishing, male-female were used, and paper dust and AC dust FINE were adhered to the connection point surface in advance to form an evaluation connector. After the connecting end face of the connector was brought into contact with the surface of the cleaning tape using the cleaning heads of Examples and Comparative Examples, the guide pins and the surface of the connecting end face of the connector were observed to confirm the presence or absence of contamination by transferring dust to the pins and the removability of the connecting end face of the connector. The observation was carried out at an arbitrary magnification using a microscope (Keyence; model VHX-500F). The cleaning performance is determined to be acceptable when the entire surface of the connector is cleaned, and is determined to be unacceptable when the entire surface of the connector is not cleaned, such as when a portion where cleaning is not performed remains. The results are shown in Table 1.

### (Tape Conveyance Property)

The adhesiveness of the entire surface of the tape of each of Examples and Comparative Examples was evaluated by the following method.

When the cleaner is operated and the cleaning tape is conveyed, it is determined that the case where the cleaning tape is smoothly conveyed and displaced without wrinkling of the cleaning tape is passed, and the case where wrinkles of the cleaning tape are not formed and the conveying and displacement of the cleaning tape cannot be smoothly performed and a defect occurs in the conveying of the cleaning tape is not passed. The results are shown in Table 1.

In addition, as the total evaluation, the case where both the tape full adhesion and the tape conveyance property are ⊚ is evaluated as ⊚, the case where ○ is present in any one of the items is evaluated as ○, and the case where × is present is evaluated as ×. The results are shown in Table 1.

### REFERENCE SIGNS LIST

10 cleaner

100 housing

140 coil spring

200 supply reel

300 take-up reel

400 cleaning head

440 head holder

500 winding control body

CT cleaning tape

RL adhesive layer

MF Maximum forward position

MR Maximum rear position

1-10. (Cancelled)

11. An optical connector end surface cleaner for cleaning an end surface of an optical connector,
the optical connector end surface cleaner comprising:
a cleaning tape for cleaning the end surface of the optical connector in contact the end surface of an optical connector;
a cleaning head for supporting a rear surface of the cleaning tape in contact with an end surface of the optical connector when the cleaning tape is in contact with the end surface of the optical connector;
and a tape supply mechanism for supplying the cleaning tape to the cleaning head,
wherein the cleaning head comprises at least a cleaning head distal end member, a cleaning head buffering member, and a cleaning head supporting member,
and a storage elastic modulus E1 of the cleaning head buffering member at 40° C. measured in accordance with JIS K7244-4 with a frequency of 1 Hz is lower than a storage elastic modulus E2 of the cleaning head distal end member at 40° C. and a storage elastic modulus E3 of the cleaning head supporting member at 40° C., which are similarly measured.

12. The optical connector end surface cleaner according to claim 11,
wherein at least a part of the cleaning head buffering member is arranged in contact with a position where a cleaning head distal end member is sandwiched between an end surface of the optical connector and the cleaning head buffering member on an optical axis of an optical fiber provided in the optical connector when the cleaning tape is brought into contact with the end surface of the optical connector,
and the storage elastic modulus E1 is 0.05 to 1.0 Mpa.

13. The optical connector end surface cleaner according to claim 11, wherein a ratio of the storage elastic modulus E2 to the storage elastic modulus E1 (E2/E1) is 500 or more.

14. The optical connector end surface cleaner according to claim 12, wherein a ratio of the storage elastic modulus E2 to the storage elastic modulus E1 (E2/E1) is 500 or more.

15. The optical connector end surface cleaner according to claim 11, wherein the storage elastic modulus E3 has a ratio to the storage elastic modulus E1 (E3/E1) is 500 or more.

16. The optical connector end surface cleaner according to claim 12, wherein the storage elastic modulus E3 has a ratio to the storage elastic modulus E1 (E3/E1) is 500 or more.

17. The optical connector end surface cleaner according to claim 13, wherein the storage elastic modulus E3 has a ratio to the storage elastic modulus E1 (E3/E1) is 500 or more.

18. The optical connector end surface cleaner according to claim 14, wherein the storage elastic modulus E3 has a ratio to the storage elastic modulus E1 (E3/E1) is 500 or more.

19. The optical connector end surface cleaner according to claim 11, wherein the cleaning tape comprises an adhesive layer, and a ratio of the storage elastic modulus E1 to a storage elastic modulus E4 of the adhesive layer at 40° C. measured according to JIS K7244-4 with a frequency of 1 Hz (E1/E4) is 1 to 7.5.

20. The optical connector end surface cleaner according to claim 12, wherein the cleaning tape comprises an adhesive layer,
and a ratio of the storage elastic modulus E1 to a storage elastic modulus E4 of the adhesive layer at 40° C. measured according to JIS K7244-4 with a frequency of 1 Hz (E1/E4) is 1 to 7.5.

21. The optical connector end surface cleaner according to claim 13, wherein the cleaning tape comprises an adhesive layer,
and a ratio of the storage elastic modulus E1 to a storage elastic modulus E4 of the adhesive layer at 40° C. measured according to JIS K7244-4 with a frequency of 1 Hz (E1/E4) is 1 to 7.5.

22. The optical connector end surface cleaner according to claim 15, wherein the cleaning tape comprises an adhesive layer,
and a ratio of the storage elastic modulus E1 to a storage elastic modulus E4 of the adhesive layer at 40° C. measured according to JIS K7244-4 with a frequency of 1 Hz (E1/E4) is 1 to 7.5.

23. The optical connector end surface cleaner according to claim 18, wherein the cleaning tape comprises an adhesive layer,
and a ratio of the storage elastic modulus E1 to a storage elastic modulus E4 of the adhesive layer at 40° C. measured according to JIS K7244-4 with a frequency of 1 Hz (E1/E4) is 1 to 7.5.

24. The optical connector end surface cleaner according to claim 19, wherein the end surface of the optical connector has a guide pin protruded parallel to the optical axis of the optical fiber,
the cleaning head distal end member has a cleaning head end surface for pressing the cleaning tape against the end surface of the optical connector, and the cleaning head end surface has an accommodation hole (A) into which the guide pin is inserted at a position opposed to the guide pin when the cleaning head end surface is pressed against the end surface of the optical connector.

25. The optical connector end surface cleaner according to claim 23, wherein the end surface of the optical connector has a guide pin protruded parallel to the optical axis of the optical fiber,
the cleaning head distal end member has a cleaning head end surface for pressing the cleaning tape against the end surface of the optical connector, and the cleaning head end surface has an accommodation hole (A) into which the guide pin is inserted at a position opposed to the guide pin when the cleaning head end surface is pressed against the end surface of the optical connector.

26. The optical connector end surface cleaner according to claim 24, wherein the cleaning head buffering member has an accommodation hole (B) or a concave part (b) at a position facing the accommodation hole (A) in the cleaning head distal end member.

27. The optical connector end surface cleaner according to claim 25, wherein the cleaning head buffering member has an accommodation hole (B) or a concave part (b) at a position facing the accommodation hole (A) in the cleaning head distal end member.

28. The optical connector end surface cleaner according to claim 11, wherein the cleaning head end surface is a plane,
and a normal direction of the cleaning head end surface is parallel to an optical axis direction of an optical fiber provided on the end surface of the optical connector.

29. The optical connector end surface cleaner according to claim 11, wherein the cleaning head end surface is a plane,
and a normal direction of the cleaning head end surface is inclined by 5° to 20° with respect to an optical axis direction of an optical fiber provided on the end surface of the optical connector when the cleaning tape is brought into contact with the end surface of the optical connector.

30. The optical connector end surface cleaner according to claim 11, wherein the cleaning head end surface is a curved surface,
the cleaning head end surface has at least one maximum point,
and the maximum point is arranged on an optical axis of at least one optical fiber provided on the end surface of the optical connector when the cleaning tape is brought into contact with the end surface of the optical connector.
